(19) United States
(12) Patent Application Publication
(10) Pub. No.: US 2025/0373342 A1
(43) Pub. Date: Dec. 4, 2025

(54) SECURE OPTICAL BODY AREA NETWORK BASED ON FREE SPACE OPTICS AND TIME-DELAYED 2D-SPECTRAL/SPATIAL OPTICAL CDMA

(71) Applicant: KING FAHD UNIVERSITY OF PETROLEUM AND MINERALS, Dhahran (SA)

(72) Inventors: Khurram Karim QURESHI, Dhahran (SA); Jawad MIRZA, Islamabad (PK); Firdous KANWAL, Hajira (PK)

(73) Assignee: KING FAHD UNIVERSITY OF PETROLEUM AND MINERALS, Dhahran (SA)

(21) Appl. No.: 18/887,339

(22) Filed: Sep. 17, 2024

Related U.S. Application Data
(60) Provisional application No. 63/652,915, filed on May 29, 2024.

(51) Int. Cl. H04B 13/00; H04B 10/079; H04B 10/112

(52) U.S. Cl. CPC H04B 13/005; H04B 10/07953; H04B 10/112

(57) ABSTRACT

The present disclosure relates to an optical body area network (OBAN) comprising a plurality of on-body optical sensors each configured to generate optical signals based on respective measurements. An optical coordinator receives, spectrally and spatially encodes, time-delays, and combines these signals into a single optical data stream, which is then amplified. A transmitter telescope transmits this amplified stream over a free space optical channel to a receiver telescope. An optical decoder splits the received stream into four equal data streams, applies a decoding time delay, and spatially and spectrally decodes the four decoded equal data streams according to a 2D spatial/spectral double weight zero cross-correlation decode sequence, generating eight decoded optical signals. The OBAN includes a low pass filter to filter the decoded signals and a bit error rate (BER) estimator to perform BER measurements on the decoded signals.

### CROSS-REFERENCE TO RELATED APPLICATIONS

The present application claims the benefit of priority to U.S. Prov. App. No. 63/652,915, entitled “Secure Optical Body Area Network Based On Free Space Optics And Time-Delayed 2D-Spectral/Spatial Optical CDMA”, filed on May 29, 2024, and incorporated herein by reference in its entirety.

### STATEMENT REGARDING PRIOR DISCLOSURE BY THE INVENTORS

Aspects of this technology are described in an article “A Secure Optical Body Area Network Based on Free Space Optics and Time-Delayed 2D-Spectral/Spatial Optical CDMA” published in Applied Sciences, 2023, 42, 13(16), which is incorporated herein by reference in its entirety.

### STATEMENT OF ACKNOWLEDGEMENT

Support provided by the King Fahd University of Petroleum and Minerals (KFUPM), Riyadh, Saudi Arabia through Project No. INCS2303 is gratefully acknowledged.

### BACKGROUND

### Technical Field

The present disclosure is directed to an optical body area network based on free space optics and time-delayed two dimensional (2D) spectral/spatial optical code-division multiple access (CDMA).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A body area network (BAN), also referred to as a wireless body area network (WBAN), consists of a network of miniature battery-powered intelligent sensors equipped with wireless transmitters. Such sensors may be medical sensors (hereinafter referred to as sensors) which can be embedded inside the body as implants or mounted on the body surface. The primary function of these sensors is to provide continuous, real-time localized or remote health monitoring by recording or transmitting physiological data to medical staff.

Conventionally, a communication link in the BAN is categorized as an intra-body BAN or an extra-body BAN. The intra-body communication occurs between the sensors, or between the sensors and a coordinating device located on the same body. The extra-body communication includes additional transmission between the sensors on the body and a remote medical center or a personal device via a network coordinator.

The increasing elderly population has significantly escalated health spending due to rising global demand for medical treatment and long-term nursing. Moreover, various infectious pandemics, such as COVID-19, have further established a requirement for remote health monitoring, in addition to elevated health expenditures, necessitating the adoption of technology-oriented and cost-efficient solutions.

The BANs have increasingly been used for electronic-health systems that facilitate the sensing and timely transmission of physiological data of the patients from multiple medical sensors to remotely located medical staff. Such technological integration reduces the workload and the number of required clinical staff, thus enhancing medical staff efficiency and reducing healthcare expenditures.

The BANs were regulated by Task Group IEEE 802.15.6 standard, which published a relevant standard based on RF technology (See: Chavez-Santiago et al. “Propagation models for IEEE 802.15.6 standardization of implant communication in body area networks”, Published in IEEE Commun. Mag. 2013, 51, 80-87). The aforementioned standard was established based on a wireless channel model obtained through measurements. However, prolonged RF exposure was later found to potentially cause malfunctioning of medical equipment and even adversely affect the health of patients and medical staff. Therefore, BANs are being developed to possess high throughput while being compatible with the green radio (GR) trend, resistant to electromagnetic interference (EMI), utilizing license-free spectrum, and having low installation and maintenance costs (See: Mirza, J. et al. “Integrating ultra-wideband and free space optical communication for realizing a secure and high-throughput body area network architecture based on optical code division multiple access”. Opt. Rev. 2021, 28, 525-537). These features have recently been realized by integrating BAN and free-space optics (FSO), resulting in the technology termed optical body area network (OBAN) (See: Chevalier, L. et al “Wireless optical technology based body area network for health monitoring application”, Published in IEEE International Conference on Communications (ICC), London, UK, 8-12 Jun. 2015; pp. 2863-2868). The intra-body or extra-body communication in OBANs is facilitated through light beams in the visible or IR range that are modulated with medical sensor data.

Some technologies include secure optical body area network (OBAN) architectures based on spectral amplitude coding-optical code division multiple access (SAC-OCDMA) and optical chaos. OBANs are based on visible light communication (VLC) enabled through cameras and orthogonal spreading codes, alongside patient mobility models. Other technologies are based on FSO channel characterization and performance analysis with patient mobility (See: Haddad, O. et al. Performance analysis of optical extra-WBAN links based on realistic user mobility modeling. Opt. Eng. 2022, 61, 026113), intra-OBAN channel modeling and multiple access schemes (See: Haddad, O. et al. Wireless body-area networks in medical applications using optical signal transmission. In Proceedings of the in IEEE Optical Fiber Communications Conference and Exhibition (OFC) Virtual, 6-11 Jun. 2021; pp. 1-3), and channel modeling between sensors and a coordinator (See: Haddad, O. et al. Channel characterization and modeling for optical wireless body-area networks. IEEE Open J. Commun. Soc. 2020, 1, 760-776). A few applications have addressed channel modeling for a diffused optical channel between on-body sensors (See: Chevalier, L. et al. “Investigation of wireless optical technology for communication between on-body nodes” in Proceedings of the IEEE International Workshop on Optical Wireless Communications (IWOW), Newcastle upon Tyne, UK, 21 Oct. 2013; pp. 79-83) and a star OBAN topology based on a diffused optical channel and spreading codes (See: Chevalier, L. et al. Optical wireless links as an alternative to radio-frequency for medical body area networks, IEEE J. Sel. Areas Commun. 2015, 33, 2002-2010).

Free space optical (FSO) systems offer substantial bandwidth, cost efficiency due to reduced deployment and maintenance costs, license-free spectrum usage, EMI protection, environmental friendliness, and higher inherent security compared to RF links (See: Mirza, J.; A high bit rate free space optics based ring topology having carrier-less nodes. IET Commun. 2021, 15, 1530-1538). However, outdoor FSO channels between a coordinator and the medical center are highly vulnerable to atmospheric attenuation, turbulence, pointing errors, and eavesdropping (See: Ghafoor, S. at al; A novel technique for secure transmission of two channels using a single optical pulse position modulated signal for free space optical communication Opt. Quantum Electron. 2023, 55, 350). An attacker can intercept classified patient information transmitted over FSO channels with minimal effort using simple methods, such as a wiretap installed in close proximity to the receiver or a receiver placed inside the divergence region of the beam (See: Eghbal, M. et al; Security enhancement in free-space optics using acousto-optic deflectors. J. Opt. Commun. Netw. 2014, 6, 684-694). Minimizing the probability of interception is imperative by adopting effective measures to ensure the secure transmission of classified patient data over FSO channels using OBANs.

Various hardware-based techniques, including optical chaos, pulse position modulation (PPM), quantum communication, and spectral amplitude coding optical code division multiple access (SAC-OCDMA), have been implemented for securing data transmission in OBANs against interception. The operational principle of SAC-OCDMA systems includes converting binary data into the spectral domain using a specific code. This allows or blocks specific data bits through an arrangement of optical filters, splitters, and couplers on the encoder side, with information retrieval on the decoder side using a similar setup. SAC-OCDMA codes are classified into zero cross-correlation (ZCC) and fixed in-phase cross-correlation codes. These codes are further utilized to create one-dimensional (1D), two-dimensional (2D), and three-dimensional (3D) SAC-OCDMA codes, leveraging temporal, spatial, spectral, and polarization characteristics of signals. Spectral/spatial combinations are commonly employed, resulting in the development of various 2D codes for SAC-OCDMA systems.

Currently, no 2D SAC-OCDMA codes have been designed to support OBANs. Nevertheless, due to the efficient performance of the SAC-OCDMA family and their ability to cancel MAI, various 2D variants have been designed by combining 1D SAC-OCDMA codes. 2D multidiagonal (MD) codes by applying ZCC 1D MD codes have been implemented (See: Kadhim, R. A. et al.; A new two dimensional spectral/spatial multi-diagonal code for noncoherent optical code division multiple access (OCDMA) systems. Opt. Commun. 2014, 329, 28-33). However, binary ones in the multidiagonal code are not placed adjacent to one another, increasing the code length as more users are added to the network. Additionally, nonadjacent placement increases the complexity of the code along with the design of encoder and decoder modules. Few applications have utilized a combination of 1D ZCC and MD codes to develop a 2D hybrid ZCC/MD code (See: Matem, R. et al; Performance analysis of spectral/spatial of OCDMA system using 2D hybrid ZCC/MD code. Indones. J. Electr. Eng. Comput. Sci. 2019, 13, 569-574).

However, ZCC employs code sequences with w=3, which places an upper bound on the total number of users, as the code length is proportional to the weight of the code. Additionally, both codes have nonadjacent placement of binary ones. A 2D permutation vector (PV) code is developed based on the help of 1D PV code. Each code is characterized by length, weight, and cross-correlation properties such that the length of the code depends on the number of users and the weight of the code. One of the drawbacks associated with this code is the limited number of code patterns that can be developed while maintaining the fundamental code properties. Additionally, with a few exceptions, most such codes are developed with nonadjacent placement of ones.

Diagonal eigenvalue unity (DEU) is utlized to develop a 2D spectral/spatial coding scheme (See: Najjar, M. et al. Spectral/spatial optical CDMA code based on diagonal eigenvalue unity. Opt. Fiber Technol. 2017, 38, 61-69). However, the DEU code is developed with λc=1, necessitating a relatively complex receiver structure to overcome the multiple access interference (MAI). A polarization technique to increase the cardinality of the system has been developed. However, the polarization technique does not compress the SAC-OCDMA code, as polarization is applied for each user, which is inefficient for a higher number of users.

US20240056200A1, incorporated herein by reference in its entirety, describes a body area network including a plurality of ultra-wideband (UWB) BAN node devices, a control node device, and a remote node device in which a spectral amplitude encoder modulates the signals from the BAN node devices, combines the signals, and transmits the combined signal over a free space network to a remote node device, which decodes the signals. However, the reference does not use any encoding, as a result of which the signals are vulnerable to threats or attacks.

Each of the aforementioned references presents advancements in the optimization and control of OBANs but also possesses limitations in their scope and capability, failing to address specific elements critical to the secure and efficient design and management of integrated OBAN systems for medical applications. The identified references do not suggest a comprehensive method that combines the use of a two-dimensional spatial/spectral double weight zero cross-correlation code with time-delay techniques to optimize the secure transmission of medical sensor data over FSO channels in OBANs.

Thus, there exists a need for an integrated system to enhance the design and secure transmission/reception management of OBANs in remote medical applications. There is also a need for a method for optimal capacity planning and operation of hybrid OBANs with optical sensors, optical coordinators, and FSO channels. Accordingly, it is one of the objectives of the system and method to provide a system and method for integrating two-dimensional spatial/spectral double weight zero cross-correlation code and time-delay techniques to optimize the secure, reliable, and efficient transmission of medical sensor data over FSO channels in OBANs.

### SUMMARY

In an exemplary embodiment, an optical body area network includes a plurality of on-body optical sensors Kᵢ, where i=1, 2, . . . , 8. Each on-body optical sensor is configured to generate optical signals based on a measurement by the respective on-body optical sensor. The optical body area network further includes an optical coordinator configured to receive the optical signals from each on-body optical sensor Kᵢ, spectrally and spatially encode the optical signals according to a two dimensional (2D) spectral/spatial double weight zero cross correlation code, apply an encoded time delay to the spectrally and spatially encoded optical signals, combine the encoded time delayed spectrally and spatially encoded optical signals into a single optical data stream, and amplify the single optical data stream. The optical body area network further includes a transmitter telescope configured to receive the amplified single optical data stream and transmit the amplified single optical data stream over a free space optical channel, and a receiver telescope configured to receive the amplified single optical data stream. The optical body area network further includes an optical decoder configured to split the received amplified single optical data streams into four equal received data streams, apply a decoded time delay to each of the four equal received optical data streams, spatially and spectrally decode the four decoded time delayed equal received optical data streams according to a 2D spatial/spectral double weight zero cross correlation decode sequence, and generate eight decoded optical signals. The optical body area network further includes a low pass filter configured to low pass filter the eight decoded optical signals, and a bit error rate BER estimator configured to perform a BER measurement on each of the eight decoded optical signals.

In another exemplary embodiment, a method for transmission of optical body area network signals over a free space optical network is described. The method includes generating, by each of a plurality of on-body optical sensors Kᵢ, where i=1, 2, . . . , 8, optical signals based on a measurement by a respective on-body optical sensor, receiving, by an optical coordinator, the optical signals from each on-body optical sensor Kᵢ, and spectrally and spatially encoding, by the optical coordinator, the optical signals according to a two dimensional (2D) spectral/spatial double weight zero cross correlation code. The method further includes applying, by the optical coordinator, an encoded time delay to the spectrally and spatially encoded optical signals, combining, by an optical coupler, the encoded time delayed spectrally and spatially encoded optical signals into a single optical data stream, amplifying, by an amplifier, the single optical data stream, and receiving, by a transmitter telescope, the amplified single optical data stream. The method further includes transmitting the amplified single optical data stream over a free space optical channel, receiving, by a receiver telescope, the amplified single optical data stream, splitting, by an optical decoder, the received amplified single optical data streams into four equal received data streams, and applying, by the optical decoder, a decoding time delay to each of the four equal received optical data streams. The method further includes spatially and spectrally decoding, by the optical decoder, the four decoded time delayed equal received optical data streams according to a 2D spatial/spectral double weight zero cross correlation decode sequence, generating, by the optical decoder, eight decoded optical signals, low pass filtering, by a low pass filter, the eight decoded optical signals, performing, by a bit error rate BER estimator, a BER measurement on each of the eight decoded optical signals, and verifying, by the bit error rate BER estimator, signal reception when the BER is greater than or equal to 1×10⁻⁹.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a block diagram of an optical body area network (OBAN) implemented for remote health monitoring applications, according to certain embodiments.

FIG. 2 illustrates an exemplary architecture of the OBAN for remote health monitoring applications, according to certain embodiments.

FIG. 3A illustrates a graph of a bit error rate (BER) versus received optical power plots for sensors 1, 2, 5, and 6 under light haze conditions, where αₐₜₘ=2 dB/km, according to certain embodiments.

FIG. 3B illustrates a graph of a Q-factor versus received optical power for sensors 1, 2, 5, and 6 under light haze conditions, where αₐₜₘ=2 dB/km, according to certain embodiments.

FIG. 3C illustrates a graph of the BER versus received optical power for sensors 1, 2, 5, and 6 under heavy haze conditions, where αₐₜₘ=11 dB/km, according to certain embodiments.

FIG. 3D illustrates a graph of the Q-factor versus received optical power for sensors 1, 2, 5, and 6 under heavy haze conditions, where αₐₜₘ=11 dB/km, according to certain embodiments.

FIG. 3E illustrates a graph of the BER versus received optical power plots for sensors 1, 2, 5, and 6 under heavy fog conditions, where αₐₜₘ=21 dB/km, according to certain embodiments.

FIG. 3F illustrates a graph of the Q-factor versus received optical power for sensors 1, 2, 5, and 6 under heavy fog conditions, where αₐₜₘ=21 dB/km, according to certain embodiments.

FIG. 4A illustrates an eye diagram of a received signal for sensor 1 at the output of a lowpass filter (LPF), where a weak turbulence regime was characterized

$${C}_{n}^{2}$$

value of 5×10⁻¹⁶ m^{-2/3}, and where αₐₜₘ=2 dB/km, according to certain embodiments.

FIG. 4B illustrates an eye diagram of the received signal for a sensor 5 at the output of the LPF, where a weak turbulence regime was characterized by

$${C}_{n}^{2}$$

value of 5×10−¹⁶ m^{-2/3}, and where αₐₜₘ=2 dB/km, according to certain embodiments.

FIG. 4C illustrates an eye diagram of the received signal for sensor 1 at the output of the LPF, where a weak turbulence regime was characterized by

$${C}_{n}^{2}$$

value of 5×10−¹⁶ m^{-2/3}, and where αₐₜₘ=11 dB/km, according to certain embodiments.

FIG. 4D illustrates an eye diagram of the received signal for sensor 5 at the output of the LPF, where a weak turbulence regime was characterized by

$${C}_{n}^{2}$$

value of 5×10−¹⁶ m^{-2/3}, and where αₐₜₘ=11 dB/km, according to certain embodiments.

FIG. 4E illustrates an eye diagram of the received signal for sensor 1 at the output of the LPF, where a weak turbulence regime was characterized by

$${C}_{n}^{2}$$

value of 5×10−¹⁶ m^{-2/3}, and where αₐₜₘ=21 dB/km, according to certain embodiments.

FIG. 4F illustrates an eye diagram of the received signal for sensor 5 at the output of the LPF, where a weak turbulence regime was characterized by

$${C}_{n}^{2}$$

value of 5×10−¹⁶ m^{-2/3}, and where αₐₜₘ=21 dB/km, according to certain embodiments.

FIG. 5A is a graphical representation of the Q-factor versus the FSO range for sensor 1 under various atmospheric attenuation conditions, according to certain embodiments.

FIG. 5B is a graphical representation of the Q-factor versus the FSO range for sensor 5 under various atmospheric attenuation conditions, according to certain embodiments.

FIG. 6A is a graphical representation of the BER and Q-factor versus an aperture diameter of the receiver telescope for sensor 1 at an atmospheric attenuation of 21 dB/km, according to certain embodiments.

FIG. 6B is a graphical representation of the BER and Q-factor versus an aperture diameter of the receiver telescope for sensor 5 at the atmospheric attenuation of 21 dB/km, according to certain embodiments.

FIG. 7A is a graphical illustration of the BER and Q-factor versus beam divergence for sensor 1 at the atmospheric attenuation of 21 dB/km, according to certain embodiments.

FIG. 7B a graphical illustration of the BER and Q-factor versus beam divergence for sensor 5 at the atmospheric attenuation of 21 dB/km, according to certain embodiments.

FIG. 8A is a block diagram of a conventional 2D-spectral/spatial FSO system, according to certain embodiments.

FIG. 8B a block diagram of a 2D-spectral/spatial FSO with induced time delay system, according to certain embodiments.

FIG. 9 is an illustration of a non-limiting example of details of computing hardware used in the computing system, according to certain embodiments.

FIG. 10 is an exemplary schematic diagram of a data processing system used within the computing system, according to certain embodiments.

FIG. 11 is an exemplary schematic diagram of a processor used with the computing system, according to certain embodiments.

FIG. 12 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to an optical body area network (OBAN) utilizing free space optics (FSO) technology, implemented to overcome the constraints associated with radio frequency (RF)-based systems. The OBAN incorporates a plurality of sensors affixed to a body of patients, each sensor operating at a predefined a data rate, for example at 50 kbps. The sensors are configured to measure various physiological parameters and generate corresponding electrical data. The electrical data is subsequently utilized to modulate an optical carrier, which is then encoded employing a two-dimensional (2D) spectral/spatial double weight zero cross-correlation (DW-ZCC) code. The encoded optical signals are subjected to time delays and combined to mitigate the issue of multiple parallel FSO channels existing between the transmitter and the medical center.

The resultant combined optical signal, which comprises a plurality of 2D-encoded time-delayed optical signals, is transmitted over an FSO channel spanning a distance of 1 km, to a remote medical center. Upon reception at the medical center, the optical signal undergoes decoding, and the data from each sensor is extracted post-photodetection for further analysis. The performance evaluation of these sensors is conducted by analyzing bit-error-rate (BER) and quality factor (Q-factor) plots under different weather conditions and varying lengths of the FSO channel, with considerations based on a log-normal channel model.

The OBAN architecture offers substantial benefits, including high capacity, immunity to electromagnetic interference (EMI), expedited installation, cost-efficiency, and license-free spectrum utilization. Additionally, a comparative analysis of the capital expenditure (CAPEX) of the OBAN architecture of the present disclosure against conventional 2D-spectral/spatial FSO systems was conducted to evaluate the financial implications of integrating time delay units into the system.

The coding of the OBAN system ensures the secure transmission of patient health data, safeguarding against potential interceptions within FSO channels. The OBAN system represents a flexible and cost-effective solution for remote health monitoring, effectively addressing the inherent challenges associated with RF-based OBANs. The OBAN system also provides a robust mechanism for the secure and efficient transmission of critical patient data.

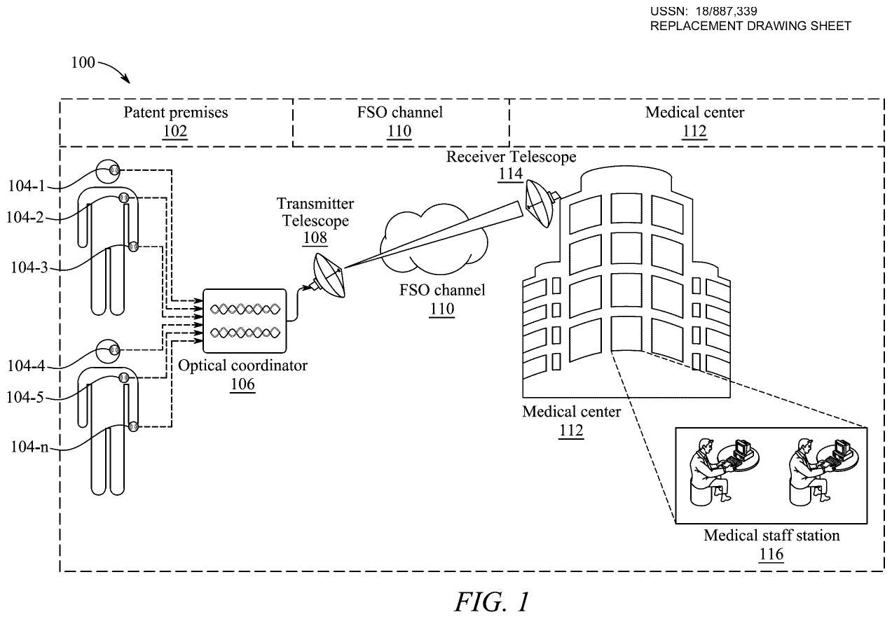

FIG. 1 is a block diagram of an OBAN 100 implemented for remote health monitoring applications. The remote health monitoring applications, also interchangeably referred to as e-health solutions, are implemented for remote health monitoring of subjects. Remote health monitoring is used for elderly individuals, as well as for ailing or disabled persons residing in old age homes, areas affected by pandemics, or in situations where they face obstacles in direct interaction with medical personnel. However, e-health solutions including remote health monitoring can also be used for any patient. The e-health solutions may offer significant benefits in scenarios requiring enhanced physician and patient engagement, improvements in clinical quality, adherence to evidence-based medication, and reduction in medical expenses. Commercial e-health solutions are configured with various technologies, including AI-enabled health devices, mobile health tracking, telemedicine, patient portals, blockchain electronic health records, and such health monitoring solutions. Examples of commercial e-health solutions include, but are not limited to, Vantage Health® Doctor-on-Demand®, Practo®, Inside Tracker®, and Precision Nutrition®.

The OBAN 100 for the e-health solutions includes various components interconnected to enable secure and efficient transmission of physiological data from patients to medical staff. Various components of the OBAN 100 are implemented at both a patient premises 102 and a medical center 112 having signal transmission facilitated through an FSO channel 110.

The patient premises 102 refers to the designated area where the patient/subject resides or stays, which can be a room in a hospital, a healthcare facility, an elderly care home, home of the patient and the like. The patient premises 102 is equipped with infrastructure to support the operation of the OBAN 100 system. At the patient premises 102, one or more patients are kept under observation by optical body area networks. Physiological data related to the one or more patients is converted into optical signals. The optical signals are transmitted from the patient premises 102, by a transmitter telescope 108 through the FSO channel 110, to the medical center 112. In a non-limiting example, the transmitter telescope 108 may be an MX10C optical transmitter, produced by Thorlabs Inc., New Jersey, United States of America.

The OBAN 100 includes a plurality of on-body optical sensors Kᵢ. In one non-limiting example, i=1, 2, 3, . . . , 8. The plurality of on-body optical sensors (104-1, 104-2, . . . , 104-8), collectively referred to as on-body optical sensors 104, are mounted on the bodies of patients. Each on-body optical sensor 104 is configured to generate optical signals based on a measurement by the respective on-body optical sensor 104. The on-body optical sensors 104 measure physiological parameters, such as body temperature, pulse rate, coughing, blood pressure, electrocardiogram (ECG) signals, electroencephalogram (EEG) signals, oxygen saturation level, and blood glucose level. Each of the on-body optical sensors 104 generates optical signals based on these measurements. Examples of the on-body optical sensors 104 include a body temperature sensor, a pulse rate sensor, a cough sensor, a blood pressure sensor, an electroencephalogram (EEG) sensor, an oxygen saturation level sensor, a blood glucose level sensor, and the like. In one example, the oxygen saturation level sensors measure the amount of oxygen carried by red blood cells and convert this information into optical signals.

The OBAN 100 further includes an optical coordinator 106, located at a fixed position within the patient premises 102. The optical coordinator 106 receives the optical signals from the on-body optical sensors 104, encodes the signals using a 2D spectral/spatial DW-ZCC code, and combines the encoded signals into an optical data stream. In an example, the optical data stream may be a single optical data stream. The 2D spectral/spatial DW-ZCC is a type of optical code used in optical code-division multiple access (OCDMA) systems. The OCDMA is a technique used in optical networks to allow multiple users to share the same transmission medium simultaneously, while maintaining high data security and reducing interference. The DW-ZCC code, specifically, is designed to improve the performance of such systems by minimizing cross-correlation, which in turn reduces interference between users.

The optical coordinator 106 processes and synchronizes the data received from multiple sensors, ensuring that the combined signal is accurately transmitted.

Conventionally, 1D optical code division multiple access (1D-OCDMA) codes have been used for encoding and decoding optical signals. The 1D-OCDMA codes are based on spectral amplitude coding (SAC) and are recognized for their simplicity and efficiency as one-dimensional (1D) codes. The 1D-OCDMA codes have been implemented in conventional systems for mitigating a multiple access interference (MAI) through the use of balanced detection. Furthermore, the 1D-OCDMA coding exhibits high spectral efficiency and includes inherent security features. However, the 1D-OCDMA coding is inefficient when managing an increasing number of on-body sensors. To address this limitation of 1D-OCDMA codes, multidimensional OCDMA codes were developed by combining different signal characteristics.

The spectral and spatial encoding and decoding combination approach is utilized to implement two-dimensional (2D) OCDMA codes. In accordance with the present disclosure, 2D-spectral/spatial DW-ZCC code is configured by integrating 1D DW-ZCC codes within both the spectral and spatial domains. The 2D codes, such as quick response (QR) codes, are graphical images that store information both horizontally and vertically, in contrast to traditional one-dimensional (1D) barcodes, which contain data in a single direction. This characteristic enables 2D codes to store significantly more data than 1D barcodes, accommodating up to 3,000 characters as opposed to the 30-character limit of 1D barcodes. Additionally, 2D codes are known for their high readability and resistance to poor printing quality, due to the redundant data they contain, which allows the code to remain legible even if some cells are damaged.

The DW family of codes includes three variants, double weight (DW), modified double weight (MDW), and enhanced double weight (EDW). The term “double weight” is derived from the characteristic that chips of the code sequence are positioned adjacent to one another. Such characteristic endows DW codes with advantages over their existing counterparts, due to the ease of design and implementation, reducing the number of filters required in the encoder and decoder. For example, in the context of the DW-ZCC code, “double weight” implies that a first sensor code is placed adjacent to a second sensor data sequence. For instance, positioned next to results in [11000011] within the code sequence, incorporating additional zeroes. The adjacency in the code sequence is illustrated in the accompanying figures, highlighting the superior design and implementation efficiency of DW codes.

Each DW code possesses unique characteristics pertaining to its weight (w), auto-correlation properties (λₐ), cross-correlation properties (λ_{c}), and code length (l_{c}). Within the DW code family, the DW code represents the earliest developed code. In examples, the DW code is structured as a K×N matrix, where K denotes the number of sensors and N signifies the code length. The basic 2×3 DW code matrix is defined as:

$${Z}_{B} = {[ \begin{matrix}1 & 1 & 0 \\ 0 & 1 & 1\end{matrix} ]}_{2 \times 3} \qquad ( 1 )$$

The conventional DW code has w=2, λ_{c}=1, and the code length l_{c} is given by:

$${l}_{c} = \frac{3 K}{2} + {\frac{1}{2} [ sin \frac{K π}{2} ]}^{2} \qquad ( 2 )$$

To develop a code with adjacent code placement and zero cross-correlation property, the conventional DW code matrix can be modified accordingly. The conventional DW code matrix is modified as:

$${Z}_{B} = {[ \begin{matrix}1 & 1 & 0 & 0 \\ 0 & 0 & 1 & 1\end{matrix} ]}_{2 \times 4} \qquad ( 3 )$$

The DW-ZCC code matrix has w=2, λ_{c}=0, and l_{c}=x×K, where x is the distance between symbols.

In implementations, reducing the cross-correlation property to an ideal zero increases the code length in comparison to its conventional counterpart. Furthermore, the code length in equation (3) is directly proportional to the number of users. However, long code lengths are disadvantageous in practical implementations as they require either very wideband sources or very narrow filter bandwidths.

Therefore, to ensure a large cardinality system, this disclosure introduces a two-dimensional (2D) spectral/spatial DW-ZCC code. The 2D spectral/spatial DW-ZCC code employs one-dimensional (1D) DW-ZCC codes along the spectral domain and spatial domain (the X^{th} and Y^{th} axes, respectively). The length of both code sequences depends on the weight and the total number of code words.

The code is represented by (M×N, w, λₐ, λ_{c}), where M×N signifies the size of the 2D-spectral/spatial DW-ZCC code, w denotes the weight of the code, and λₐ and λ_{c} respectively represent the auto- and cross-correlation properties of the DW-ZCC code. Let Y{y₁, y₂, y₃, . . . , y_{N}} represent the 1D DW-ZCC code sequences employed in the spatial domain, and let X{₁, x₂, x₃, . . . , x_{N}} be the 1D DW-ZCC code sequences utilized in the spectral domain. An example of two different 1D enhanced multi-diagonal (EMD) sets X and Y with w₁=2 and w₂=2 is shown in Table 1.

TABLE 1
Spectral (X) and spatial (Y) code sequences
extracted from 1D DW-ZCC code.

| X^{th} Code Sequences | Y^{th} Code Sequences |
|---|---|
| X₁ = {1100} | Y₁ = {0011} |
| X₂ = {0011} | Y₂ = {1100} |

Both the X^{th} and Y^{th} code sequences are used to build the 2D-spectral/spatial DW-ZCC code matrix of the disclosure as described below. Table 2 shows the 2D-spectral/spatial DW-ZCC code matrix for S_{g,h} sensors obtained by combining the spectral code sequence X_{g} and spatial code sequence Yₕ as

$$D {Z}_{gh} = {Y}_{h}^{T} {X}_{g}$$

where X_{g} and

$${Y}_{h}^{T}$$

are the gₜₕ and hₜₕ code sequences of X and Y, respectively, with g=(1, 2, 3, . . . K₁) and h=(1, 2, 3, . . . K₂). Here, K₁ and K₂ respectively represent the number of codes corresponding to the number of sensors in both the spectral and spatial code sequences.

TABLE 2
2D-spectral/spatial DW-ZCC code.

| ${Y}_{h}^{T} {X}_{g}$ | X₁ = [1100] | X₂ = [0011] |
|---|---|---|
| ${Y}_{1}^{T} [ \begin{matrix}1 \\ 1 \\ 0 \\ 0\end{matrix} ]$ | $[ \begin{matrix}1 & 1 & 0 & 0 \\ 1 & 1 & 0 & 0 \\ 0 & 0 & 0 & 0 \\ 0 & 0 & 0 & 0\end{matrix} ]$ | $[ \begin{matrix}0 & 0 & 1 & 1 \\ 0 & 0 & 1 & 1 \\ 0 & 0 & 0 & 0 \\ 0 & 0 & 0 & 0\end{matrix} ]$ |
| ${Y}_{2}^{T} [ \begin{matrix}0 \\ 0 \\ 1 \\ 1\end{matrix} ]$ | $[ \begin{matrix}0 & 0 & 0 & 0 \\ 0 & 0 & 0 & 0 \\ 1 & 1 & 0 & 0 \\ 1 & 1 & 0 & 0\end{matrix} ]$ | $[ \begin{matrix}0 & 0 & 0 & 0 \\ 0 & 0 & 0 & 0 \\ 0 & 0 & 1 & 1 \\ 0 & 0 & 1 & 1\end{matrix} ]$ |

To determine the auto- and cross-correlation properties of the proposed codes, four different characteristic matrices are defined as DZ^{d}, where d∈(1, 2, 3, 4). The four codes can be represented mathematically as follows:

$${DZ}_{g , h}^{( 1 )} = {Y}_{h}^{T} {X}_{g} {DZ}_{g , h}^{( 2 )} = \overline{{Y}_{h}^{T}} {X}_{g} {DZ}_{g , h}^{( 3 )} = {Y}_{h}^{T} \overline{{X}_{g}} {DZ}_{g , h}^{( 4 )} = \overline{{Y}_{h}^{T}} \overline{{X}_{g}} \qquad ( 4 )$$

where

$$\overline{{Y}_{h}^{T}} and \overline{{X}_{g}}$$

represent the complementary code sequences for X_{g} and

$${Y}_{h}^{T} ,$$

respectively. Moreover, the 2D-spectral/spatial DW-ZCC code DZ_{g,h} is provided by a set of elements dzᵢⱼ, where i=(1, 2, 3, . . . N₁) and j=(1, 2, 3, . . . N₂). Hence, Ac for the 2D-spectral/spatial DW-ZCC code using DZ_{g,h} and DZ^{(d)} can be expressed as:

$${C}^{( d )} ( g , h ) = {\sum }_{i = 1}^{{N}_{2}} {\sum }_{j = 1}^{{N}_{1}} d {z}_{( i , j )}^{( d )} d {z}_{( i , j )} ( g , h ) ; \qquad ( 5 )$$

where

$${dz}_{( i , j )}^{( d )}$$

is the (i,j)^{th} entry of DZ^{(d)} and dz_{(i,j)}(g,h) is the (i,j)^{th} entry of DZ_{(g,h)}.

Table 3 provides the auto- and cross-correlation properties for the 2D-spectral/spatial DW-ZCC code generated from Equation (2).

TABLE 3
Correlation properties for 2D-EMD code with w₁ = 3 and w₂ = 2

| E_{g, h} | R⁽¹⁾(g, h) | R⁽²⁾(g, h) | R⁽³⁾(g, h) | R⁽⁴⁾(g, h) |
|---|---|---|---|---|
| g = 1, h = 1 | w₁w₂ | 0 | 0 | 0 |
| g = 1, h ≠ 1 | 0 | w₁w₂ | 0 | 0 |
| g ≠ 1, h = 1 | 0 | 0 | w₁w₂ | 0 |
| g ≠ 1, h ≠ 1 | 0 | 0 | 0 | w₁w₂ |

Thus, the cross-correlation of DZ^{(d)} and DZ_{(g,h)} can be denoted as:

$${C}^{( d )} ( g , h ) = {\sum }_{i = 1}^{{N}_{2}} {\sum }_{j = I}^{{N}_{1}} d {z}_{( i , j )}^{( d )} d {z}_{( i , j )} ( g , h ) = \{ \begin{matrix}{w}_{1} {w}_{0} & for g = h = 1 \\ 0 & for otherwise\end{matrix} \qquad ( 6 )$$

The auto- and cross-correlation properties derived from the 2D-spectral/spatial DW-ZCC code can be utilized to determine the receiver architectures and the detection techniques required to recover the intended signal. Each sequence exhibits maximum power units with itself and minimal or zero power units with adjacent and other codes. Consequently, a direct detection scheme can be employed at the receiver end to recover the intended signal. Optical code division multiple access (OCDMA) codes provide high levels of security, as each sensor is assigned a unique code that can only be decoded using specific equipment at the respective receiver.

This inherent security feature is significantly enhanced in the architecture of the OBAN system of the present disclosure by introducing additional dimensions in the form of spatial and temporal encoding. The extension of the one-dimensional (1D) DW-ZCC code to higher dimensions not only enhances performance but also elevates the overall security of the network, making it exceedingly challenging for an eavesdropper to recover the transmitted signal. Furthermore, code complexity affects the security of OCDMA codes, as increased code complexity can elevate the total power required to transmit the encoded signal. This increases the overall signal-to-noise ratio (SNR) required for an eavesdropper to break the encoding by only a few decibels (dB).

The 2D spectral/spatial DW-ZCC code is developed using a technique that results in limited weight and length compared to existing counterparts. Consequently, this code offers a relatively high level of security by employing adjacent code sequences and a multi-dimensional code structure with efficient performance parameters. The system of the present disclosure employs FSO channels to transmit signals between the on-body optical sensors 104 and the medical center 112. One challenge associated with FSO is its short range and dependence on weather conditions. However, these challenges can be mitigated by the unique code sequence with multiple dimensions, which reduces multiple access interference between adjacent subscribers and supports high-capacity communication over large distances.

The overall capacity and cardinality of the system depends on weather conditions. Although the system and methods of the present disclosure provide desirable performance in adverse environments, channel conditions might affect performance under certain conditions.

$$y = {g}_{x} + n = η Ix + n , \qquad ( 7 )$$

where g is the intensity gain, y is the received signal, x is the modulated optical signal, η is the photodetector (PD) conversion efficiency, I is the intensity, and n is additive white Gaussian noise (AWGN). Intensity of the received signal is considered to be affected by atmospheric attenuation, turbulence, and geometrical losses. The atmospheric attenuation huis modelled by the Beer-Lambert principle, provided by the following equation:

$${h}_{l} = exp ( - d ξ ) , \qquad ( 8 )$$

where ξ is the scattering coefficient. The scattering coefficient is weather-dependent and is a function of the visibility v, which can be calculated by:

$$ξ = \frac{3.91}{v} {( \frac{λ}{550} )}^{- 1.3} \qquad ( 9 )$$

The intensity of the received signal at the photodetector (PD) randomly fluctuates, a phenomenon referred to as intensity scintillation or turbulence. The intensity scintillation or turbulence represent a significant source of performance degradation in FSO channels 110. Various channel models have been developed to estimate turbulence, including the gamma-gamma, log-normal, and negative exponential channel models. The log-normal channel model is typically employed for weak turbulence when the FSO channel range is on the order of a few kilometers. The probability density function (PDF) of intensity of the received signal adheres to a log-normal distribution and is provided as follows:

$${p}_{I} ( I ) = \frac{1}{2 I \sqrt{2 π {σ}_{x}^{2}}} exp [ - \frac{ln {( I / {I}_{o} )}^{2}}{8 {σ}_{x}^{2}} ] \qquad ( 10 )$$

where

$${σ}_{x}^{2}$$

is the intensity variance que to turbulence, provided by:

$${σ}_{x}^{2} = 0.307 {C}_{n}^{2} {k}^{7 / 6} {L}^{11 / 6} \qquad ( 11 )$$

where L is a range of FSO channel, k=2π/λ is the wave number, and

$${C}_{n}^{2}$$

is the refractive index structure parameter. The value of the

$${C}_{n}^{2}$$

parameter is time-dependent ana varies in the range of 10⁻¹⁷ to 10⁻¹² m^{(-2/3)}, respectively indicating weak to strong turbulence.

The 2D-spectral/spatial DW-ZCC code for the plurality of on-body optical sensors 104, in one example, eight on-body optical sensors 104, are used for the implementation of an OBAN setup is provided in Table 4. The 2D-spectral/spatial DW-ZCC code uses the following four codes in the spectral domain: X1, X2, X3, and X4, and the following two codes in the spatial domain: Y1 and Y2.

TABLE 4
(divided into two parts): 2D spectral/spatial
DW-ZCC code used to implement the OBAN

| | | | X1 | | | | | | | | | | | | | | | |
|---|---|---|---|---|---|---|---|---|---|---|---|---|---|---|---|---|---|---|
| | | | λ₁ | λ₂ | | | | | | | X2 | | λ₃ | λ₄ | | | | |
| | | | 1 | 1 | 0 | 0 | 0 | 0 | 0 | 0 | 0 | 0 | 1 | 1 | 0 | 0 | 0 | 0 |
| Y1 | C1 | 1 | 1 | 1 | 0 | 0 | 0 | 0 | 0 | 0 | 0 | 0 | 1 | 1 | 0 | 0 | 0 | 0 |
| | C2 | 1 | 1 | 1 | 0 | 0 | 0 | 0 | 0 | 0 | 0 | 0 | 1 | 1 | 0 | 0 | 0 | 0 |
| | | 0 | 0 | 0 | 0 | 0 | 0 | 0 | 0 | 0 | 0 | 0 | 0 | 0 | 0 | 0 | 0 | 0 |
| | | 0 | 0 | 0 | 0 | 0 | 0 | 0 | 0 | 0 | 0 | 0 | 0 | 0 | 0 | 0 | 0 | 0 |
| Y2 | | 0 | 0 | 0 | 0 | 0 | 0 | 0 | 0 | 0 | 0 | 0 | 0 | 0 | 0 | 0 | 0 | 0 |
| | | 0 | 0 | 0 | 0 | 0 | 0 | 0 | 0 | 0 | 0 | 0 | 0 | 0 | 0 | 0 | 0 | 0 |
| | C3 | 1 | 1 | 1 | 0 | 0 | 0 | 0 | 0 | 0 | 0 | 0 | 1 | 1 | 0 | 0 | 0 | 0 |
| | C4 | 1 | 1 | 1 | 0 | 0 | 0 | 0 | 0 | 0 | 0 | 0 | 1 | 1 | 0 | 0 | 0 | 0 |

| | | X3 | | | | | | λ₅ | λ₆ | X4 | | | | | | λ₇ | λ₈ |
|---|---|---|---|---|---|---|---|---|---|---|---|---|---|---|---|---|---|
| | | 0 | 0 | 0 | 0 | 1 | 1 | 0 | 0 | 0 | 0 | 0 | 0 | 0 | 0 | 1 | 1 |
| Y1 | C1 | 0 | 0 | 0 | 0 | 1 | 1 | 0 | 0 | 0 | 0 | 0 | 0 | 0 | 0 | 1 | 1 |
| | C2 | 0 | 0 | 0 | 0 | 1 | 1 | 0 | 0 | 0 | 0 | 0 | 0 | 0 | 0 | 1 | 1 |
| | | 0 | 0 | 0 | 0 | 0 | 0 | 0 | 0 | 0 | 0 | 0 | 0 | 0 | 0 | 0 | 0 |
| | | 0 | 0 | 0 | 0 | 0 | 0 | 0 | 0 | 0 | 0 | 0 | 0 | 0 | 0 | 0 | 0 |
| Y2 | | 0 | 0 | 0 | 0 | 0 | 0 | 0 | 0 | 0 | 0 | 0 | 0 | 0 | 0 | 0 | 0 |
| | | 0 | 0 | 0 | 0 | 0 | 0 | 0 | 0 | 0 | 0 | 0 | 0 | 0 | 0 | 0 | 0 |
| | C3 | 0 | 0 | 0 | 0 | 1 | 1 | 0 | 0 | 0 | 0 | 0 | 0 | 0 | 0 | 1 | 1 |
| | C4 | 0 | 0 | 0 | 0 | 1 | 1 | 0 | 0 | 0 | 0 | 0 | 0 | 0 | 0 | 1 | 1 |

Referring to FIG. 1, the OBAN 100 further includes a transmitter telescope 108, connected to the optical coordinator 106, configured to transmit the single optical data stream from the optical coordinator 106 over the FSO channel 110 to a receiver telescope 114 located at the medical center 112. For the transmission, the transmitter telescope 108 may be equipped with optical lenses and mirrors that ensure the optical data stream is focused into a coherent light beam. The beam is then directed accurately towards the receiver telescope 114 at the medical center 112 through the FSO channel 110.

The FSO communication is an optical communication technology that uses light propagating in free space to wirelessly transmit data for telecommunications or computer networking. Term free space relates to space without constraints, such as air, outer space, vacuum, and the like, which can provide a passage for transmission. In contrast to communication channels having constraints, such as an optical fibre cable, the FSO channel 110 operates in free space. The FSO communication is mainly utilized due to its increased transmission capacity, cost efficiency, large license-free spectrum utilization, immunity to electromagnetic interference (EMI), and high security.

With respect to FIG. 1, the FSO channel 110 utilizes light beams propagating in free space to wirelessly transmit the physiological data. The FSO channel 110 utilizes network nodes that communicate optically via focused light beams. The FSO channel 110 is capable of achieving significantly higher data rates compared to traditional radio frequency (RF) communication systems. The FSO channel 110 benefits from the absence of spectrum utilization constraints typically imposed on RF systems, enabling unrestricted use of the optical spectrum and enhancing data transmission efficiency.

The physiological data transmitted by the FSO channel 110 is received at the medical center 112. The medical center 112 refers to a facility equipped with the necessary infrastructure and personnel to monitor and analyze the physiological data transmitted from the patient premises 102. The medical center 112 can be a hospital, clinic, or specialized healthcare center where medical professionals are available to provide real-time analysis and intervention based on the received data. The medical center 112 includes the receiver telescope 114, the optical decoder (not shown in FIG. 1), and a medical staff station 116.

The receiver telescope 114 is implemented to receive the optical data stream transmitted from the transmitter telescope 108 through the FSO channel 110. The optical data stream is then decoded by the optical decoder. In a non-limiting example, the receiver telescope 114 may be a 1801-FS-AC silicon optical receiver including a 320 to 1000 nm AC coupled photoreceiver which offers a well-balanced combination of gain, bandwidth, and low noise over the 25 kHz to 125 MHz frequency range, produced by Newport corporation, Irvine, California, United States of America.

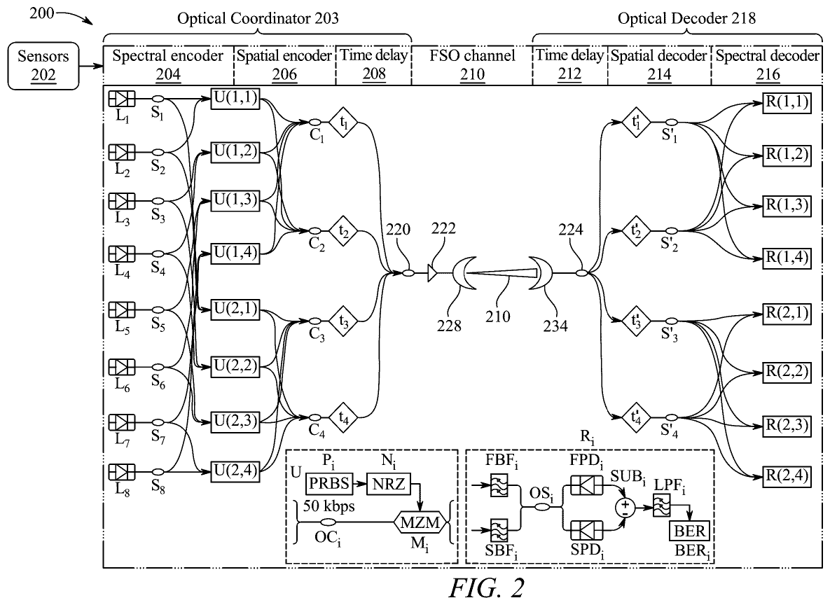

The optical decoder 218 (shown in FIG. 2) splits the received optical data stream into multiple decoded optical signals according to the 2D spectral/spatial DW-ZCC decode sequence. The optical decoder converts the combined optical data stream back into individual decoded optical signals, corresponding to the original measurements taken by the on-body optical sensors 104. The decoding process is performed for accurate data interpretation and analysis at the medical center 112.

The optical decoder operates, in one implementational aspect, by utilizing a two-dimensional (2D) spectral/spatial double weight zero cross-correlation (DW-ZCC) decode sequence.

The optical decoder utilizes spectral decoding methods to differentiate between various wavelengths used in the combined optical data stream. By using a series of optical filters, the optical decoder can isolate specific wavelengths associated with data of each sensor. Such spectral separation renders the accurate retrieval of individual sensor measurements.

The optical decoder utilizes spatial decoding methods to further separate the optical data stream. In an aspect, spatial separation is used in combination with the spatial decoding. Spatial decoding methods use beam splitters and spatial light modulators to direct different portions of the optical signal to designated decoding paths. The spatial separation ensures that each decoded signal corresponds accurately to the originating on-body optical sensor 104.

A zero cross-correlation (ZCC) code is a binary sequence with enhanced auto correlation and cross correlation properties, such as the cross correlation between any two sequences remains zero throughout.

The DW-ZCC code is designed to minimize crosstalk and interference between different optical signals in optical communication systems. The DW-ZCC is structured to ensure that when multiple optical signals are transmitted simultaneously, the signals can be distinguished from one another with minimal interference. The DW-ZCC code assigns a unique code sequence to each optical signal, characterized by double weights and zero cross-correlation properties. The double weight aspect refers to ability of the code to represent two distinct levels or states, enhancing the capacity to encode information. The zero cross-correlation property ensures that the cross-correlation between different code sequences is zero, meaning that the codes are orthogonal to each other. The orthogonality contributes in reducing cross-talk, as it allows the optical decoder to accurately distinguish and decode the signals even when they overlap in the communication channel. Thus, the 2D spectral/spatial DW-ZCC decode sequence separates the combined optical data stream into its constituent parts, allowing for the retrieval of individual sensor signals obtained by each of the on-body optical sensors 104.

The optical decoder further includes an array of photodetectors that convert the decoded optical signals into electrical signals. The photodetectors are sensitive to optical signals and capable of detecting minute variations in the optical signal intensity, ensuring precise signal conversion. The signal processing algorithms are implemented within the optical decoder to refine the decoded signals and eliminate residual noise or interference.

Processed and refined signals are then analysed by medical staff at the medical staff station 116. The medical staff station 116 is a central computing system accessed by the medical staff, such as doctors, nurses, and such medical practitioners. Such manual inspection ensures accurate and timely monitoring of physiological parameters of the patients.

FIG. 2 illustrates an exemplary architecture of an OBAN 200 for remote health monitoring applications. The OBAN 200, earlier described as the OBAN 100 in conjunction with FIG. 1, includes the optical coordinator 203 for receiving the optical signals from each of a plurality of on-body optical sensor 202. In a non-limiting example, eight on-body optical sensors 202 have been implemented. The on-body optical sensors 202 (Kᵢ), where i=1, 2, . . . , 8, are configured to generate electrical data signals that are transmitted to an optical coordinator, which is then utilized to perform the encoding in the optical domain. The number of the on-body optical sensors 202 varies based upon a number of physiological data parameters to be measures and monitored.

The optical signals from the on-body optical sensors 202 are received by the optical coordinator 203. The optical coordinator 203 is configured to receive the optical signals from each on-body optical sensor 202, and then spectrally and spatially encode the optical signals according to a two dimensional (2D) spectral/spatial DW-ZCC code. The optical coordinator 203 includes a spectral encoder 204, a spatial encoder 206, and a plurality of time delay units 208. Initially, the optical coordinator 203 spectrally and spatially encodes the signals using the two-dimensional (2D) spectral/spatial DW-ZCC code. After encoding, an encoded time delay is applied to the signals. The optical coordinator 203 then combines the encoded time-delayed signals into a single optical data stream and amplifies this stream for transmission.

For spectral encoding, the spectral encoder 204 includes a plurality of continuous wave (CW) lasers Lᵢ, a plurality of power splitters Sᵢ, and an optical modulator Uᵢ including a plurality of optical combiners OCᵢ, and a plurality of Mach-Zehnder modulators Mᵢ.

A number of the plurality of CW laser Lᵢ is based on the number of the on-body optical sensors 202. Output of each on-body optical sensor 202 is provided to at least one CW laser Lᵢ to generate an optical data stream. In one non-limiting example, each of the plurality of CW lasers Lᵢ, where i=1, 2, . . . , K, is configured to generate an optical data stream based on the received optical signals from respective on-body optical sensor 202. The CW lasers Lᵢ are a type of laser that emits a constant beam of light, as opposed to pulsed lasers that emit light in short bursts. CW lasers Lᵢ are characterized by their continuous output, which is essential for applications requiring stable and consistent illumination over time.

A number of power splitters Sᵢ is based on the number of CW lasers Lᵢ. Output of each CW laser Lᵢ is provided to at least one power splitter Sᵢ. In one non-limiting example, where eight on-body optical sensors 202 and eight CW lasers Lᵢ have been implemented, the plurality of power splitters Sᵢ, where i=1, 2, . . . , 8, are implemented so that each power splitter can split each optical data stream, transmitted by each CW laser Lᵢ, into two equal length optical data streams. Power splitters Sᵢ are optical devices that divide an incoming light signal into multiple output signals. A 50:50 power splitter, in particular, divides the input light equally into two output signals, each carrying 50% of the original power.

According to the non-limiting example, where eight on-body optical sensors 202 are implemented, eight CW lasers (L₁, L₂, L₃, L₄, L₅, L₆, L₇, and L₈) and eight power splitters (S₁, S₂, S₃, S₄, S₅, S₆, S₇, and S₈) are implemented in correspondence with the eight on-body optical sensors 202. For example, physiological data measured by first sensor is converted into an optical signal by first CW laser L₁. The optical signal is then split into two output signals, each carrying 50% of the original power, by first power splitter S₁. Each signal, representing physiological data measured by each on-body optical sensors 202, is thus converted into two optical split output signals by corresponding CW laser Lᵢ and power splitter Sᵢ.

Each of the CW lasers Lᵢ has a power output of 10 dBm, ensuring sufficient intensity for effective data transmission over the FSO channel 210. Each CW laser Lᵢ is centered at specific wavelengths to minimize interference and maximize the efficiency of spectral encoding. In the non-limiting example of K equal to eight, the specific wavelengths are λ₁=1552.5 nm, λ₂=1551.7 nm, λ₃=1550.9 nm, λ₄=1550.1 nm, λ₅=1549.3 nm, λ₈=1548.5 nm, λ₇=1547.7 nm, and λ₈=1546.9 nm.

The generated optical data streams are then split into two equal length streams by power splitters Sᵢ. The spectral encoder 204 further includes an optical modulator Uᵢ. The optical modulator Uᵢ is configured for combining equal-length optical data streams and spectrally encoding the combined data stream or differentiating the data streams and for ensuring that the transmitted signal can be correctly decoded at the receiver end and splitting the encoded combined data stream into two equal spectrally encoded data streams. In an example, where the 50:50 power splitter Sᵢ is implemented, the optical modulator Uᵢ is configured to receive the two equal-length optical output signals from the power splitter Sᵢ, combine the two equal-length optical output signals into one data stream, encode the combined data stream, and again split the encoded data stream into two equal-length spectrally encoded data streams. The plurality of the optical modulators Uᵢ is arranged in two equal sets of the optical modulators Uᵢ, where first set of optical modulators (U_{1,i}) modulates a first optical signal generated by each of the plurality of power splitter Sᵢ and a second set of optical modulators (U_{2,i}) modulates a second optical signal generated by each of the plurality of power splitter Sᵢ. The first set of optical modulators (U_{1,i}) generates two equal-length spectrally encoded data streams, whereas the second set of optical modulators (U_{2,i}) generates two equal-length spectrally encoded data streams.

In the non-limiting example where eight on-body optical sensors 202 are implemented, the plurality of optical modulators Uᵢ, where i=1, 2, . . . , K, is configured for modulating the split signal for transmission over the FSO channel 210. In this example, with reference to the first set of optical modulators Uᵢ, a first optical modulator (U_{1,1}) receives the first optical signal from the first power splitter S₁ and the second power splitter S₂. A second optical modulator (U_{1,2}) receives the first optical signal from the third power splitter S₃ and the fourth power splitter S₄. A third optical modulator (U_{1,3}) receives the first optical signal from the fifth power splitter S₅ and the sixth power splitter S₆. A fourth optical modulator (U_{1,4}) receives the first optical signal from the seventh power splitter S₇ and the eighth power splitter S₈. Once the first optical signals generated by each of the plurality of power splitters Uᵢ are modulated, the second set of optical modulators Uᵢ modulates the second optical signals generated by each of the plurality of power splitters Uᵢ. A fifth optical modulator (U_{2,1}) receives the second optical signal from the first power splitter S₁ and the second power splitter S₂. A sixth optical modulator (U_{2,2}) receives the second optical signal from the third power splitter S₃ and the fourth power splitter S₄. A seventh optical modulator (U_{2,3}) receives the second optical signal from the fifth power splitter S₅ and the sixth power splitter S₆. An eighth optical modulator (U_{2,4}) receives the second optical signal from the seventh power splitter S₇ and the eighth power splitter S₈.

Each optical modulator Uᵢ, as shown in the lower left inset of FIG. 2, includes an optical combiner OCᵢ, a Mach-Zehnder modulator (MZM) Mᵢ, a pseudo-random bit sequence (PRBS) generator Pᵢ, and a non-return to zero (NRZ) pulse generator Nᵢ.

The optical combiner OCᵢ is a device that merges multiple optical signals into a single optical output. Each optical combiner OCᵢ, where i=1, 2, . . . , K, is configured to combine one of the two equal length optical data streams with one of the two equal length optical data streams from a different power splitter and generate a combined data stream. Each combined data stream is a unique combination of equal length optical data streams.

A Mach-Zehnder modulator is an optical device used to modulate the intensity, phase, or polarization of light. MZM M; modulates the combined optical signal based on the encoded data generated by the on-body optical sensors 202. Each MZM Mᵢ performs modulation by using interference patterns created by splitting and recombining light waves. MZM Mᵢ, where i=1, 2, . . . , K, corresponding to each of the optical modulators Uᵢ is connected to the respective optical combiner OCᵢ to spectrally encode the combined data streams according to the 2D spectral/spatial DW-ZCC code, then splits each encoded stream into two equal spectrally encoded streams.

A pseudo-random bit sequence (PRBS) generator is an electronic device that generates a sequence of bits that appears random but is actually deterministic and repeatable. The PRBS generator Pᵢ, where i=1, 2, . . . , K, generates a pseudo-random sequence that serves as a reference for encoding the data. The generated bit sequence is used to create the modulation pattern applied by the MZM Mᵢ.

A NRZ pulse generator Nᵢ is an electronic device that generates a signal format where the signal level does not return to zero between consecutive bits. Each of the NRZ pulse generators Nᵢ is connected to an output terminal of one of the pseudo-random bit sequence generators, and converts the pseudo-random bit sequence into an NRZ format, which is then used to modulate the optical signal via the MZM Mᵢ.

Referring back to FIG. 2, the spatial encoder 206 of the optical coordinator 203 is implemented for encoding of multiple data streams in different spatial paths. By combining spatial encoding with spectral encoding, the OBAN significantly increases the overall data capacity. The data capacity increases due to spatial encoding introducing an additional dimension for multiplexing, allowing more data to be transmitted simultaneously without increasing the bandwidth of the optical signals.

The spatial encoder 206 includes a plurality of star couplers C. The star couplers Cᵢ, for i=1, . . . , 4, are used to couple multiple equal-length optical data streams from the MZM Mᵢ. Each star coupler Cᵢ takes one of the two equal data streams from each optical modulator Uᵢ and combines them into a single spectrally encoded data stream. As described earlier, each optical modulator Uᵢ generates two equal-length spectrally encoded data streams using MZM Mᵢ. For each optical modulator Uᵢ, at least two star couplers are implemented, one for each for one of the two equal-length spectrally encoded data streams.

In one non-limiting example, the spatial encoder 206 includes four star couplers C₁, C₂, C₃, and C₄. The first star coupler C₁ combines the first equal-length spectrally encoded data streams generated by each of the first set of optical modulators Uᵢ that encoded first optical signals from the power splitters Sᵢ by using the MZM Mᵢ. In one non-limiting example, for MZM Mᵢ, i=1, . . . , K/2. The second star coupler C₂ combines the second equal-length spectrally encoded data streams generated by each of the first set of optical modulators Uᵢ that encoded first optical signals from the power splitters Sᵢ by using the MZM Mᵢ. In one non-limiting example, for MZM Mᵢ, i=1, . . . , K/2. The third star coupler C₃ combines the first equal-length spectrally encoded data streams generated by each of the second set of optical modulators Uᵢ that encoded second optical signals from the power splitters Sᵢ by using the MZM Mᵢ. In one non-limiting example, for MZM Mᵢ, i=1, . . . , K/2. The fourth star coupler C₄ combines the second equal-length spectrally encoded data streams generated by each of the second set of optical modulators Uᵢ that encoded second optical signals from the power splitters Sᵢ by using the MZM Mᵢ. In one non-limiting example, for MZM Mᵢ, i=1, . . . , K/2.

The spatial encoding process is further refined by spatially encoding time delay units within the optical coordinator 106. A first time delay unit t₁, configured to receive the first spectrally data stream from the first star coupler C₁, applies a first encoded time delay to the first spectrally and spatially encoded data stream, generating a first time delayed spectrally and spatially encoded data stream. The second time delay unit t₂, configured to receive the second spectrally and spatially encoded data stream from the second star coupler C₂, applies a second encoded time delay to the second spectrally and spatially encoded, generating a second time delayed spectrally and spatially encoded data stream. The third time delay unit t₃, configured to receive the third spectrally and spatially encoded data stream from the third star coupler C₃, applies a third encoded time delay to the third spectrally and spatially encoded encoded data stream, generating a third time delayed spectrally and spatially encoded data stream. The fourth time delay unit t₄, configured to receive the fourth spectrally and spatially encoded data stream from the fourth star coupler C₄, applies a fourth encoded time delay to the fourth spectrally and spatially encoded encoded data stream, generating a fourth time delayed spectrally and spatially encoded data stream.

The first time delay, the second time delay, the third time delay and the fourth time delay are based on the spectral and spatial placement of each spectrally and spatially encoded data stream in the two dimensional (2D) spectral/spatial DW-ZCC code.

The time delay is calculated for each spectral/spatial encoded signal using the following equation:

$${t}_{D} = D \times {t}_{b} / S \qquad ( 9 )$$

where, D represents the chip placement in the coding design, t_{b} is the time duration of the bit, and S expresses the number of time slots. The time-delayed spectral/spatial encoded optical signals are then coupled by optical coupler 220 and amplified by amplifier 222 to a suitable power level using an optical amplifier (OA), ensuring a sufficient power budget. The amplified signal is then transmitted from the optical coordinator to the medical center over a 1 km FSO channel 210 using a transmitter telescope 228, as shown in FIG. 2. The FSO channel 210 utilized in the present disclosure is modeled using the log-normal distribution.

The optical coordinator 203 further includes an optical coupler 220 connected to each of the spatially encoding time delay units tᵢ. The optical coupler 220 within the optical coordinator 203 combines the time delayed spectrally and spatially encoded data streams into a single optical data stream.

The combined stream is then amplified by an optical amplifier 222 connected to the optical coupler 220. The amplification of the combined stream is performed to gain adequate power for transmission. The amplified single optical data stream is then transmitted from the optical coordinator 203 through the transmitter telescope 228 (referred to as the transmitter telescope 108 in FIG. 1) over the FSO channel 210 to the receiver telescope 234 located at the medical center. The transmitter telescope 228 is connected to the optical amplifier 222.

The FSO channel 210 utilizes light beams propagating in free space to transmit data wirelessly.

The optical signal transmitted over the FSO channel 210 is received using a receiver telescope 234 (referred to as the receiver telescope 114 in FIG. 1). Upon reaching the medical center, the receiver telescope 234 captures the amplified single optical data stream and forwards it to an optical decoder 218. The optical decoder 218 includes an optical decoupler 224 configured to split the received amplified single optical data stream into four equal received data streams. The optical decoupler 224 is connected to the receiver telescope 234.

For spatial decoding, the received signal is split into four equal parts, and a time delay t_{D} is introduced, at a block 212, in each spectral/spatial encoded signal according to the following equation.

$${t}_{D} = ( S - 1 - D ) \times {t}_{b} / S \qquad ( 10 )$$

The spatial decoder 214 includes a plurality of spatially decoding time delay units tᵢ′. A first spatially decoding time delay unit t₁′, configured to receive a first one of the four equal data streams, applies a first decoded time delay, and generates a first time delayed spatially decoded data stream. A second spatially decoding time delay unit t₂′, configured to receive a second one of the four equal data streams, applies a second decoded time delay, and generates a second time delayed spatially decoded data stream. A third spatially decoding time delay unit t₃′ configured to receive a third one of the four equal data streams, applies a third decoded time delay, and generates a third time delayed spatially decoded data stream. A fourth spatially decoding time delay unit t₄′, configured to receive a fourth one of the four equal data streams, applies a fourth decoded time delay, and generates a fourth time delayed spatially decoded data stream.

In one aspect, the first decoded time delay, the second decoded time delay, the third decoded time delay and the fourth decoded time delay are determined based on the distance each signal travels and the inherent propagation delays associated with their specific spectral and spatial configurations, particularly on the spectral and spatial placement of each spatially decoded data stream in the 2D spectral/spatial DW-ZCC decode sequence. As the delays are based on both spectral and spatial placements, each data stream arrives at the decoder in its correct sequence, allowing for precise reconstruction of the original signals.

Further spatial decoding is accomplished by star decouplers Sᵢ within the optical decoder 218. The star decouplers split each time delayed spatially decoded data stream into a set of equal spatially decoded data streams. In one non-limiting example, where the eight optical signals were generated initially by eight on-body optical sensors 202, the time delayed spatially decoded data stream is split into a set of four equal spatially decoded data streams.

For instance, a first star decoupler S₁′ is configured to receive the first time delayed spatially decoded data stream and split the first time delayed spatially decoded data stream into a first set of four equal spatially decoded data streams. A second star decoupler S₂′ is configured to receive the second time delayed spatially decoded data stream and split the second time delayed spatially decoded data stream into a second set of four equal spatially decoded data streams. A third star decoupler S₃′ is configured to receive the third time delayed spatially decoded data stream and split the third time delayed spatially decoded data stream into a third set of four equal spatially decoded data streams. A fourth star decoupler S₄′ is configured to receive the fourth time delayed spatially decoded data stream and split the fourth time delayed spatially decoded data stream into a fourth set of four equal spatially decoded data streams.

For spectral decoding, the optical decoder 218 incorporates a spectral decoder 216 comprising a plurality of receiver circuits Rᵢ, where i=1, 2, . . . , K, wherein each Rᵢ includes the components shown in the inset box on the lower right corner of FIG. 2. Each receiver circuit is designed to spectrally decode the received data streams. Each of the plurality of receiver circuits Rᵢ includes a first optical bandpass filter FBFᵢ, a second optical bandpass filter SBFᵢ, an optical decoupler/splitter OSᵢ, a first photodetector FPDᵢ, a second photodetector SPDᵢ, a subtractor SUBᵢ, an electrical low-pass filter LPFᵢ, and a bit error rate (BER) estimator BERᵢ. The first optical bandpass filter FBFᵢ and the second optical bandpass filter SBFᵢ in each circuit are tuned to specific wavelengths, filtering the received spatially decoded data streams to the designated frequencies. The optical coupler 220/splitter OSᵢ combines the filtered data streams and splits them into two equal filtered spatially decoded data streams. The first photodetector FPDᵢ and the second photodetector SPDᵢ generate electrical signals upon detecting the respective streams, which are then processed by the subtractor SUBᵢ to generate a difference signal. The difference signal is further filtered by the electrical low-pass filter LPFᵢ. The BER estimator BERᵢ assesses the bit error rate of the filtered difference signal to verify signal reception, ensuring the accurate recovery and analysis of physiological data of the patient.

Particularly for spectral decoding, the first receiver circuit R₁ includes a first optical bandpass filter FBFᵢ. The first optical bandpass filter FBFᵢ is configured to receive a first one of the first set of four equal spatially decoded data streams from the first star decoupler S₁′. Additionally, a second optical bandpass filter SBFᵢ is configured to receive a first one of the second set of four equal spatially decoded data streams from the second star decoupler S₂′. The optical bandpass filters (FBFᵢ, SBFᵢ) are each tuned to the frequency λ₁=1552.5 nm. The optical coupler 220/splitter combines spatially decoded data streams from the first optical bandpass filter FBFᵢ and the second optical bandpass filter SBFᵢ and splits them into two equal filtered spatially decoded data streams. The first photodetector FPDᵢ generates a first electrical signal from one of the equal filtered streams, while the second photodetector SPDᵢ generates a second electrical signal from the other equal filtered stream. The subtractor SUBᵢ processes these signals by subtracting the second electrical signal from the first, resulting in a difference signal. The difference signal is then processed by the electrical low pass filter LPFᵢ to produce a low pass filtered difference signal. The bit error rate estimator uses this signal to estimate the BER; and verify signal reception when the BER is greater than or equal to 1×10⁻⁹.

The second receiver circuit R₂ includes a first optical bandpass filter FBFᵢ. The first optical filter is configured to receive a second one of the first set of four equal spatially decoded data streams from the first star decoupler S₁′. Additionally, a second optical bandpass filter SBFᵢ is configured to receive a second one of the second set of four equal spatially decoded data streams from the second star decoupler S₂′. The first optical bandpass filter and the second optical bandpass filter (FBFᵢ, SBFᵢ), respectively, are each tuned to filter the received spatially decoded data streams to the frequency λ₂=1551.7 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPFᵢ receives the difference signal and generates a low pass filtered difference signal. The bit error rate estimator BER; estimates the BER of the low pass filtered difference signal and verifies signal reception when the BER is greater than or equal to 1×10⁻⁹.

The third receiver circuit R₃ includes a first optical bandpass filter FBFᵢ. The first optical bandpass filter is configured to receive a third one of the first set of four equal spatially decoded data streams from the first star decoupler S₁′. Additionally, a second optical bandpass filter SBFᵢ is configured to receive a third one of the second set of four equal spatially decoded data streams from the second star decoupler S₂′. The first optical bandpass filter FBFᵢ and the second optical bandpass filter SBFᵢ are each tuned to filter the received spatially decoded data streams to the frequency λ₃=1550.9 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPFᵢ receives the difference signal. The bit error rate estimator BERᵢ estimates the BER of the difference signal and verifies signal reception when the BER is greater than or equal to 1×10⁻⁹.

The fourth receiver circuit R₄ includes a first optical bandpass filter FBFᵢ. The first optical bandpass filter is configured to receive a fourth one of the first set of four equal spatially decoded data streams from the first star decoupler S₁′. Additionally, a second optical bandpass filter SBFᵢ is configured to receive a fourth one of the second set of four equal spatially decoded data streams from the second star decoupler S₂′. The first optical bandpass filter FBFᵢ and the second optical bandpass filter FBFᵢ are each tuned to filter the received spatially decoded data streams to the frequency λ₄=1550.1 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUB; subtracts the second electrical signal from the first electrical signal and generates a difference signal. The electrical low pass filter LPF; receives the difference signal. The bit error rate estimator BERᵢ estimates the BER of the difference signal and verifies signal reception when the BER is greater than or equal to 1×10⁻⁹.

The fifth receiver circuit R₅ includes a first optical bandpass filter. The first optical bandpass filter FBFᵢ is configured to receive a first one of the third set of four equal spatially decoded data streams from the third star decoupler S₃′. Additionally, a second optical bandpass filter SBFᵢ is configured to receive a first one of the fourth set of four equal spatially decoded data streams from the fourth star decoupler S₄′. The first optical bandpass filter and the second optical bandpass filter are each tuned to filter the received spatially decoded data streams to the frequency λ₅=1549.3 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPFᵢ receives the difference signal. The bit error rate estimator BERᵢ estimates the BER of the difference signal and verifies signal reception when the BER is greater than or equal to 1×10⁻⁹.

The sixth receiver circuit R₆ includes a first optical bandpass filter FBFᵢ. The first optical bandpass filter FBFᵢ is configured to receive a second one of the third set of four equal spatially decoded data streams from the third star decoupler S₃′. Additionally, a second optical bandpass filter SBFᵢ is configured to receive a second one of the fourth set of four equal spatially decoded data streams from the fourth star decoupler S₄′. The first optical bandpass filter FBFᵢ and the second optical bandpass filter SBFᵢ are each tuned to filter the received spatially decoded data streams to the frequency λ₆=1548.5 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPFᵢ receives the difference signal. The bit error rate estimator BERᵢ estimates the BER of the difference signal and verifies signal reception when the BER is greater than or equal to 1×10⁻⁹.

The seventh receiver circuit R₇ includes a first optical bandpass filter FBFᵢ. The first optical bandpass filter FBFᵢ is configured to receive a third one of the third set of four equal spatially decoded data streams from the third star decoupler S₃′. Additionally, a second optical bandpass filter SBFᵢ is configured to receive a third one of the fourth set of four equal spatially decoded data streams from the fourth star decoupler S₄′. The first optical bandpass filter FBFᵢ and the second optical bandpass filter SBFᵢ are each tuned to filter the received spatially decoded data streams to the frequency λ₇=1547.7 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPF; receives the difference signal. The bit error rate estimator BERᵢ estimates the BER of the difference signal and verifies signal reception when the BER is greater than or equal to 1×10⁻⁹.

The eighth receiver circuit R₈ includes a first optical bandpass filter FBFᵢ. The first optical bandpass filter FBFᵢ is configured to receive a fourth one of the third set of four equal spatially decoded data streams from the third star decoupler S₃′. Additionally, a second optical bandpass filter SBFᵢ is configured to receive a fourth one of the fourth set of four equal spatially decoded data streams from the fourth star decoupler S₄′. The first optical bandpass filter FBFᵢ and the second optical bandpass filter SBFᵢ are each tuned to filter the received spatially decoded data streams to the frequency λ₈=1546.9 nm. An optical coupler/splitter OSᵢ combines the filtered spatially decoded data streams and splits them into two equal filtered spatially decoded data streams. The first photodetector FPDᵢ generates a first electrical signal upon detecting a first of the two equal filtered spatially decoded data streams. The second photodetector SPDᵢ generates a second electrical signal upon detecting a second of the two equal filtered spatially decoded data streams. The subtractor SUBᵢ subtracts the second electrical signal from the first electrical signal and generates a difference signal. The electrical low pass filter LPF; receives the difference signal. The bit error rate estimator BERᵢ estimates the BER of the difference signal and verifies signal reception when the BER is greater than or equal to 1×10⁻⁹.

FIG. 2 illustrates a non-limiting example of the OBAN architecture with eight sensors 202 being implemented in the network. However, the number of the OBAN components is not limited to the illustrated example. The OBAN architecture is configured based on a number of physiological parameters to be measured. In one example, 16 on-body optical sensors 202 are mounted on the bodies of patients. For 16 on-body optical sensors 202, 16 CW lasers Lᵢ and 16 power splitters Sᵢ are implemented. Each CW laser Lᵢ is configured to generate an optical signal corresponding to the data measured by the respective on-body optical sensor 202. Thus, 16 CW lasers Lᵢ generate 16 optical signals. With the consideration that the power splitters Sᵢ are 50:50 power splitters Sᵢ, each optical signal is split into 2 equal-length optical data streams, i.e., a first equal-length optical data stream and a second equal-length optical data stream, by the power splitters Sᵢ. Therefore, for 16 optical signals, 32 equal-length optical data streams are generated.

To modulate the equal-length optical data streams, 16 optical modulators Uᵢ are implemented. The optical modulators Uᵢ are categorized into two equal sets, each set having 8 optical modulators Uᵢ. First set of optical modulators Uᵢ is configured to modulate all first equal-length optical data streams. Each optical modulator Uᵢ, from the first set of optical modulators Uᵢ, obtains two equal-length optical data streams from two power splitters Sᵢ. For example, a first optical modulator U_{(1,1)} from the first set of optical modulators Uᵢ obtains a first equal-length optical data stream from the first power splitter S₁ and a first equal-length optical data stream from the second power splitter S₂. A second optical modulator U_{(1,2)} from the first set of optical modulators Uᵢ obtains a first equal-length optical data stream from the third power splitter S₃ and a first equal-length optical data stream from the fourth power splitter S₄, and so on. Each optical modulator Uᵢ is configured for combining two equal-length optical data streams to generate a single data stream, encoding the single data stream, and splitting the encoded data stream into two encoded optical streams, a first encoded optical streams and a second encoded optical streams.

Similarly, the second set of the optical modulators Uᵢ is configured to modulate the second equal-length optical data streams generated by each power splitter Sᵢ. For example, a first optical modulator U_{(2,1)} from the second set of optical modulators Uᵢ obtains a second equal-length optical data stream from the first power splitter S₁ and a second equal-length optical data stream from the second power splitter S₂, and so on. Thus, 16 optical modulators modulate 32 equal-length optical data streams and generate 32 encoded optical data streams. These 32 encoded optical data streams include 8 first encoded optical data streams corresponding to the first set of optical modulators U_{(1,i)}, 8 second encoded optical data streams corresponding to the first set of optical modulators U_{(1,i)}, 8 first encoded optical data streams corresponding to the second set of optical modulators U_{(2,i)}, and 8 second encoded optical data streams corresponding to the second set of optical modulators U_{(2,i)}.

As described earlier, each star coupler is implemented to combine multiple optical data streams from various optical modulator. Therefore, in one example, four star couplers are implemented, and each star coupler is configured to combine 8 encoded optical data streams. A first star coupler may combine the 8 first encoded optical data streams corresponding to the first set of optical modulators. A second star coupler may combine the 8 second encoded optical data streams corresponding to the first set of optical modulators. A third star coupler may combine the 8 first encoded optical data streams corresponding to the second set of optical modulators. A fourth star coupler may combine the 8 second encoded optical data streams corresponding to the second set of optical modulators.

Each star coupler Cᵢ then combines the 8 encoded optical data streams into a single encoded optical data stream. The single encoded optical data stream is applied with a predefined time delay. Four single encoded optical data streams are then combined into a combined optical signal by an optical coupler.

The combined optical signal is transmitted to the medical center through the FSO channel 210, where a decoding sequence similar to encoding is implemented to recover the optical signals transmitted from the on-body optical sensors 202.

A summary of the simulation parameters is shown in Table 5.

TABLE 5
Simulation parameters

| Sr. No | Parameter | Value | |
|---|---|---|---|
| 1 | Power of CW lasers | 10 | dBm |
| 2 | Data rate of sensors | 50 | kbps |
| 3 | Extinction ratio of MZMs | 30 | dB |
| 4 | Gain of optical amplifier | 25 | dB |
| 5 | Noise figure of optical amplifier | 4 | dB |
| 6 | Range of FSO channel | 1 | km |
| 7 | Refractive index structure parameter | 5 × 10⁻¹⁶ | m^{-2/3} |
| 8 | Receiver aperture diameter | 20 | cm |
| 9 | Transmitter aperture diameter | 5 | cm |
| 10 | Beam divergence | 2 | mrad |
| 11 | Responsivity of PDs | 0.9 | A/W |
| 12 | Bandwidth of OBPFs | 0.08 | nm |

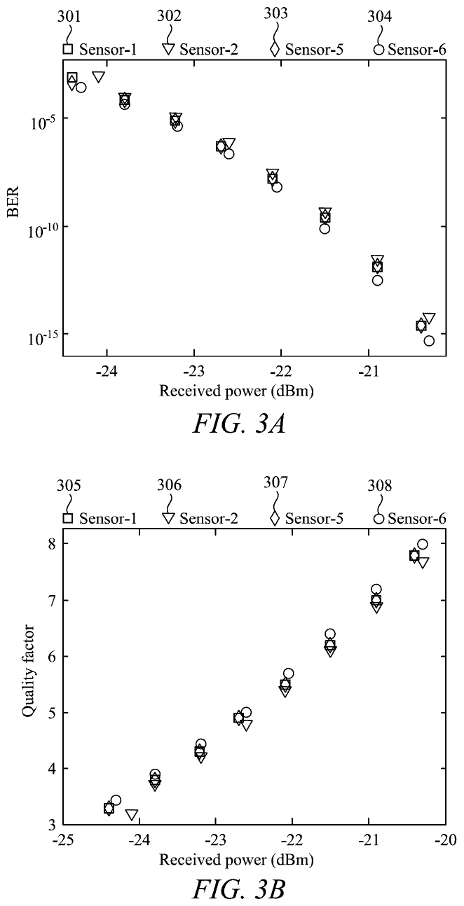

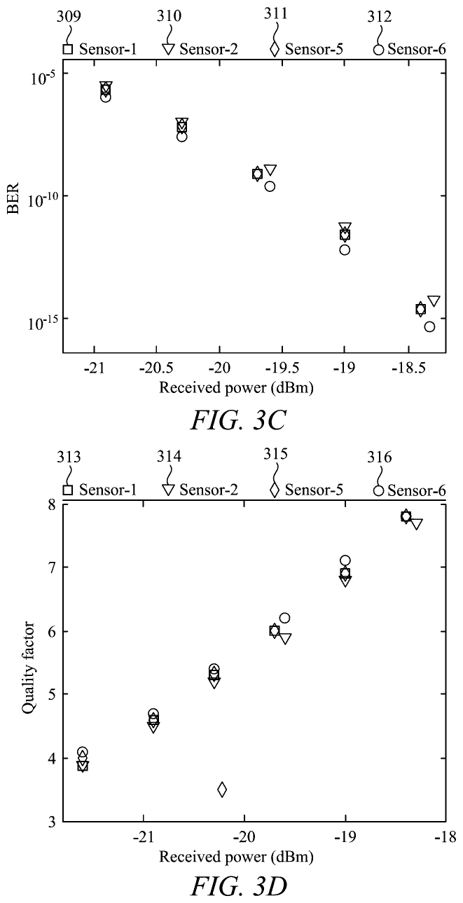

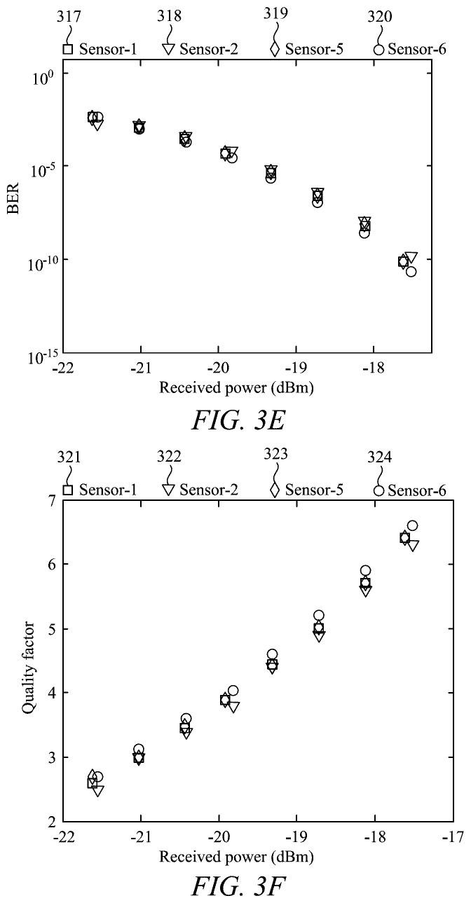

FIG. 3A illustrates a graph plotted for the bit error rate (BER) versus received optical power plots for on-body optical sensors 1, 2, 5, and 6 under light haze conditions, characterized by an atmospheric attenuation coefficient (αₐₜₘ) of 2 dB/km. The horizontal axis denotes the received power in dBm, while the vertical axis shows the BER. The BER values were calculated using the statistical method in OptiSystem by observing the eye diagram of the received signal at the output of the lowpass filter (LPF), as shown in the inset of FIG. 2. The minimum value of optical power received at the photodetector (PD) required to achieve a BER of 10⁻⁹ is called the receiver sensitivity. It can be seen from FIG. 3A that the receiver sensitivity value of sensors 1, 2, 5, and 6, as shown by curves 301, 302, 303, and 304, respectively (that is, the curves are formed by joining the values), is approximately −21.5 dBm for αₐₜₘ=2 dB/km.

FIG. 3B illustrates a graph of the quality factor (Q-factor) versus received optical power for sensors 1, 2, 5, and 6 under light haze conditions, where αₐₜₘ=2 dB/km. The horizontal axis represents the received power in dBm, while the vertical axis represents the Q-factor. The Q-factor values were obtained by analyzing the quality of the received optical signal at different power levels. It is observed that the Q-factor values of the sensors 1, 2, 5, and 6, as shown by curves 305, 306, 307, 308, respectively, typically increases with the received optical power, indicating improved signal quality.

FIG. 3C depicts a graph of the BER versus received optical power for sensors 1, 2, 5, and 6 under heavy haze conditions, characterized by an atmospheric attenuation coefficient, where αₐₜₘ=11 dB/km. The receiver sensitivity value of sensors 1, 2, 5, and 6, as shown by curves 309, 310, 311, 312, respectively, shifts to approximately-19.6 dBm for αₐₜₘ=11 dB/km. A power penalty of around 1.9 dBm is observed when increasing the value of αₐₜₘ from 2 dB/km to 11 dB/km, indicating the impact of higher atmospheric attenuation on the received signal quality.

FIG. 3D illustrates a graph of the Q-factor versus received optical power plots for sensors 1, 2, 5, and 6 under heavy haze conditions, where αₐₜₘ=11 dB/km. Similar to light haze conditions, the Q-factor increases with the increase in received optical power. However, the Q-factor values of sensors 1, 2, 5, and 6, as shown by curves 313, 314, 315, and 316, respectively, are generally lower than those observed under light haze conditions for the same received power, reflecting the degradation in signal quality due to increased atmospheric attenuation.

FIG. 3E illustrates a graph of the BER versus received optical power plots for sensors 1, 2, 5, and 6 under heavy fog conditions, characterized by an atmospheric attenuation coefficient, where αₐₜₘ=21 dB/km. The receiver sensitivity value of sensors 1, 2, 5, and 6, as shown by curves 317, 318, 319, and 320, respectively, further degrades to approximately-17.5 dBm for αₐₜₘ=21 dB/km. A power penalty of around 2.1 dBm is noticed on further increasing the value of αₐₜₘ from 11 dB/km to 21 dB/km, indicating the severe impact of heavy fog on the received signal quality.

FIG. 3F illustrates a graph of the Q-factor versus received optical power for sensors 1, 2, 5, and 6 under heavy fog conditions, where αₐₜₘ=21 dB/km. The Q-factor values for sensors 1, 2, 5, and 6, as shown by curves 321, 322, 323, and 324, respectively decrease significantly compared to light haze and heavy haze conditions for the same received power, reflecting the impact of severe atmospheric attenuation on signal quality. The Q-factor values of the sensors typically increase with the received optical power but are generally lower compared to lighter atmospheric conditions.

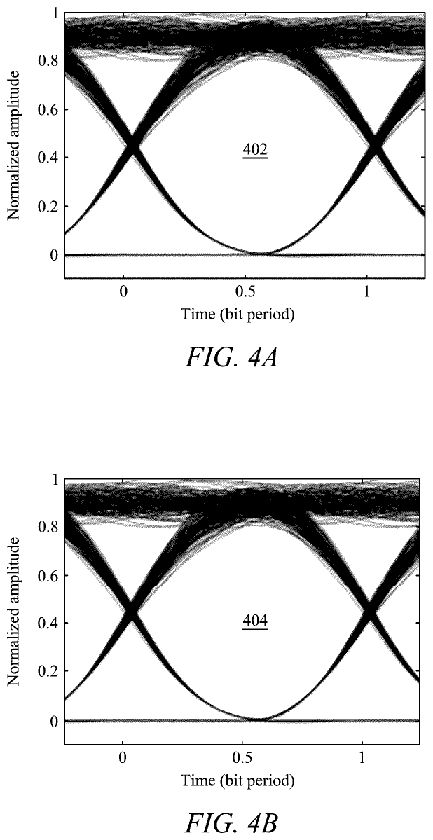

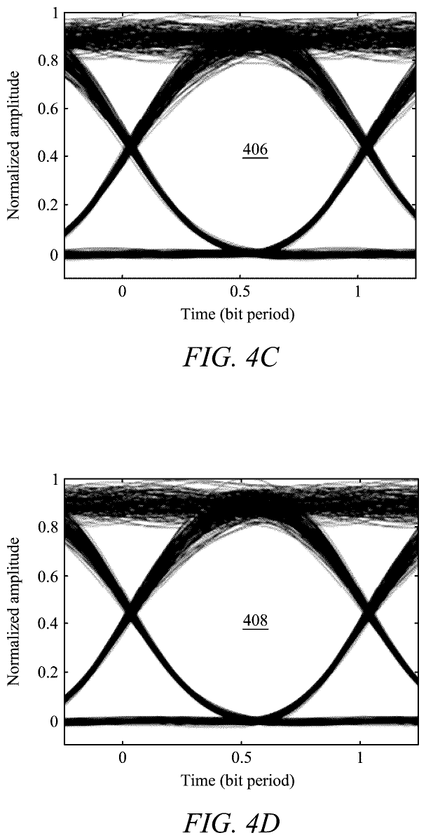

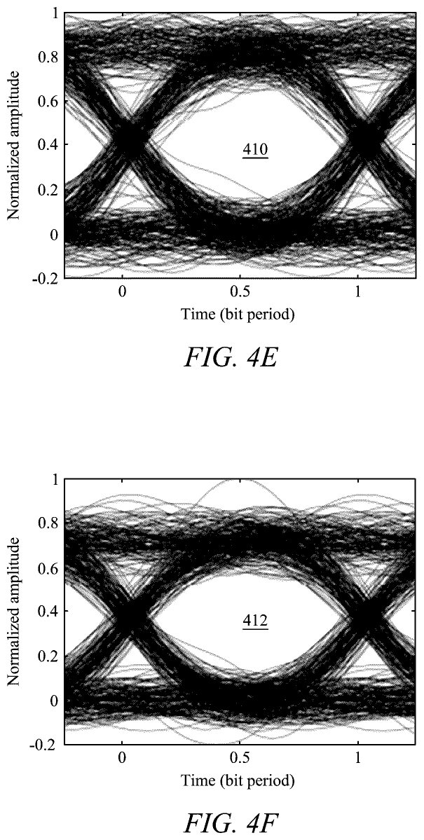

FIG. 4A illustrates an eye diagram of normalized amplitude versus time of the received signal for sensor 1 at the output of a lowpass filter (LPF), where a weak turbulence regime was characterized by

$${C}_{n}^{2}$$

value of 5×10⁻¹⁶ m^{-2/3}, and where αₐₜₘ=2 dB/km. Eye 402 represents a change in normalized amplitude of the received signal over the time. Eye 402 shows the signal quality with a wide eye opening, indicating good signal integrity. The horizontal axis represents the time, and the vertical axis represents the signal amplitude. The eye opening is wide, which signifies that the received signal has minimal distortion and noise, allowing for easier discrimination between the logical zeros and ones at the receiver.

FIG. 4B depicts the eye diagram of the received signal for a sensor 5 at the output of the LPF, where a weak turbulence regime was characterized by

$${C}_{n}^{2}$$

value of 5×10⁻¹⁶ m^{-2/3}, and where αₐₜₘ=2 dB/km. Eye 404 represents a change in normalized amplitude of the received signal over the time. Eye 404 also shows a wide opening, similar to sensor 1, indicating high-quality signal reception with minimal degradation.

FIG. 4C presents the eye diagram of the received signal for sensor 1 at the output of the LPF, where a weak turbulence regime was characterized by

$${C}_{n}^{2}$$

value of 5×10⁻¹⁶ m^{-2/3}, and where αₐₜₘ=11 dB/km. Eye 406 represents a change in normalized amplitude of the received signal over the time. Eye 406 shows a moderately closed eye opening compared to light haze, indicating some level of signal degradation due to increased atmospheric attenuation. The reduced eye-opening implies higher signal distortion and noise, making it slightly more challenging to distinguish between logical zeros and ones.

FIG. 4D illustrates the eye diagram of the received signal for sensor 5 at the output of the LPF, where a weak turbulence regime was characterized by

$${C}_{n}^{2}$$

value of 5×10⁻¹⁶ m^{-2/3}, and where αₐₜₘ=11 dB/km. Eye 408 represents a change in normalized amplitude of the received signal over the time. Eye 408 exhibits similar characteristics to FIG. 4C, with a moderately closed eye opening. The eye 408 indicates that sensor 5 experiences comparable signal degradation under heavy haze conditions, impacting the overall signal quality and increasing the difficulty of accurate signal detection.

FIG. 4E shows the eye diagram of the received signal for sensor 1 at the output of the LPF, where a weak turbulence regime was characterized by

$${C}_{n}^{2}$$

value of 5×10⁻¹⁶ m^{-2/3}, and where αₐₜₘ=21 dB/km. Eye 410 represents a change in normalized amplitude of the received signal over time. Eye 410 demonstrates a significantly closed eye opening, indicating substantial signal degradation due to severe atmospheric attenuation. The narrow eye opening signifies high levels of distortion and noise, complicating the process of distinguishing between logical zeros and ones at the receiver.

FIG. 4F depicts the eye diagram of the received signal for sensor 5 at the output of the LPF, where a weak turbulence regime was characterized by

$${C}_{n}^{2}$$

value of 5×10⁻¹⁶ m^{-2/3}, and where αₐₜₘ=21 dB/km. Eye 412 represents a change in the normalized amplitude of the received signal over time. Eye 412 exhibits similar characteristics to FIG. 4E, with a significantly closed eye opening. Eye 412 represents the severe impact of heavy fog on signal quality, resulting in considerable signal degradation and increased difficulty in accurate signal detection and interpretation.

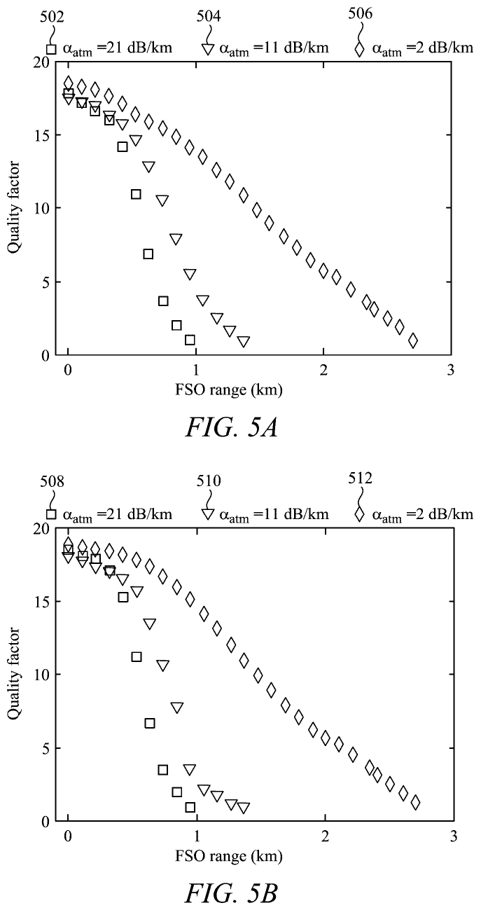

FIG. 5A presents a graphical representation of the Q-factor versus the FSO range for sensor 1 under different atmospheric attenuation conditions. The horizontal axis represents the FSO range in kilometers, while the vertical axis represents the Q-factor. The plot indicates that the range for sensor 1 is around 2.75 km at an atmospheric attenuation of 2 dB/km, as shown by curve 506, 1.4 km at an atmospheric attenuation of 11 dB/km, as shown by curve 504, and approximately 1 km at an atmospheric attenuation of 21 dB/km, as shown by curve 502, corresponding to a Q-factor of 1. The results demonstrate that the Q-factor decreases as the FSO range increases for all atmospheric conditions, highlighting the effect of atmospheric attenuation on signal quality.

FIG. 5B illustrates the Q-factor versus the FSO range for sensor 5 under different atmospheric attenuation conditions. Similar to FIG. 5A, the horizontal axis represents the FSO range in kilometers, and the vertical axis represents the Q-factor. The plot shows that the range for sensor 5 is around 2.75 km at an atmospheric attenuation of 2 dB/km, as shown by curve 512, 1.4 km at an atmospheric attenuation of 11 dB/km, as shown by curve 510, and approximately 1 km at an atmospheric attenuation of 21 dB/km, as shown by curve 508. The results indicate that the Q-factor decreases with increasing FSO range, emphasizing the impact of atmospheric conditions on the signal quality for sensor 5.

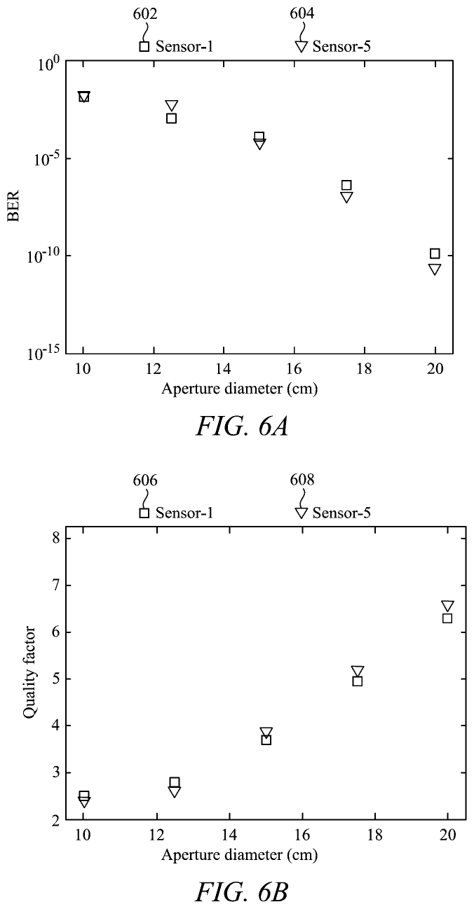

FIG. 6A presents a graphical representation of the BER and Q-factor versus an aperture diameter of the receiver telescope for sensor 1 at an atmospheric attenuation of 21 dB/km. The horizontal axis represents the receiver aperture diameter in centimeters, while the vertical axes represent the BER and Q-factor. Curve 602 of sensor 1 and curve 604 of sensor 2 show that increasing the receiver aperture diameter decreases the BER and increases the Q-factor, indicating improved signal reception and quality for sensor 1 as the aperture diameter increases.

FIG. 6B illustrates a graphical representation of the BER and Q-factor versus an aperture diameter of the receiver telescope for sensor 5 at an atmospheric attenuation of 21 dB/km. The horizontal axis represents the receiver aperture diameter in centimeters, while the vertical axes represent the BER and Q-factor. Similar to FIG. 6A, curve 606 of sensor 1 and curve 608 of sensor 2 show that increasing the receiver aperture diameter decreases the BER and increases the Q-factor, demonstrating enhanced signal reception and quality for sensor 5 with a larger aperture diameter.

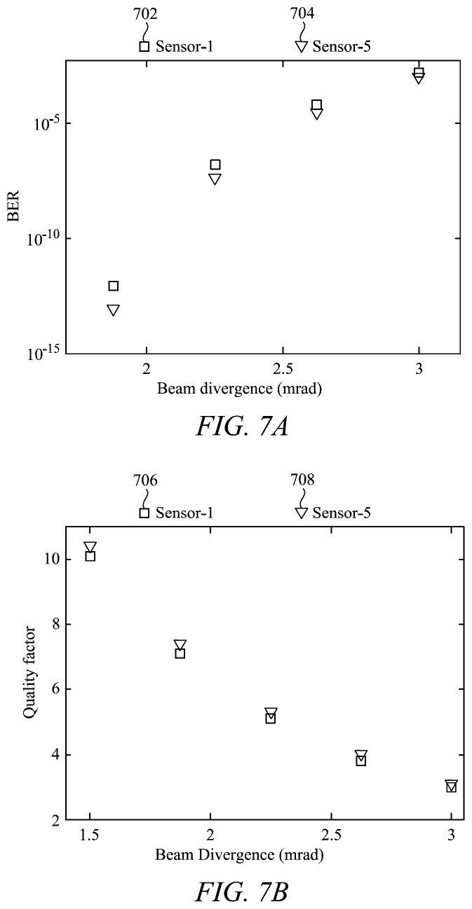

FIG. 7A presents a graphical illustration of the BER and Q-factor versus beam divergence for sensor 1 at an atmospheric attenuation of 21 dB/km. The horizontal axis represents the beam divergence in milliradians (mrad), while the vertical axes represent the BER and Q-factor. Curve 702 of sensor 1 and 704 of sensor 5 indicate that increasing the beam divergence increases the BER and decreases the Q-factor, highlighting the negative impact of larger beam divergence on signal quality for sensor 1.

FIG. 7B illustrates a graphical illustration of the BER and Q-factor versus beam divergence for sensor 5 at an atmospheric attenuation of 21 dB/km. The horizontal axis represents the beam divergence in milliradians (mrad), while the vertical axes represent the BER and Q-factor. Similar to FIG. 7A, Curve 706 of sensor 1 and 708 of sensor 5 show that increasing the beam divergence increases the BER and decreases the Q-factor, demonstrating the adverse effect of larger beam divergence on signal quality for sensor 5.

FIG. 8A and FIG. 8B are described with reference to capital expenditure (CAPEX) of an architecture of the OBAN configuration of the present disclosure. The OBAN configuration analyzed in comparison with the conventional 2D-spectral/spatial FSO system to determine the overall impact of introducing the time-delay units on the cost of implementation. The CAPEX refers to the funds used by an organization to acquire, upgrade, and maintain physical assets such as property, industrial buildings, or equipment. The CAPEX is often used to undertake new projects or investments by the organization.

For analysis of the CAPEX with respect to the conventional system and the OBAN configuration of the present disclosure, the following system parameters and components were considered for both the described and conventional 2D-spectral/spatial FSO systems:
Analysis was performed for sixteen nodes with K₁=4 and K₂=4, where K₁ and K₂ respectively represent the number of spectral and spatial codes.
Spectral/spatial encoders and decoders were the same for both architectures, as substantial modifications were made in the star coupler section through the introduction of time-delay units for the described architecture. Therefore, analysis was carried out for the components between the power couplers and combiners.
The per-unit cost of the FSO transceiver module was considered in the analysis through a market survey.

FIG. 8A illustrates a block diagram of the conventional 2D-spectral/spatial FSO system 800-1. The system 800-1 includes a plurality of star couplers (C₁, C₂, C₃, and C₄) and a plurality of star decouplers (S₁, S₂, S₃, and S₄). Each pair of a star coupler and a star decoupler is connected by a dedicated FSO link to avoid interference between repeated codes. For example, a first star coupler C₁ and a first star decoupler Sᵢ are connected by a first dedicated FSO channel 802-1. A second star coupler C₂ and a second star decoupler S₂ are connected by a second dedicated FSO channel 802-2. A third star coupler C₃ and a third star decoupler S₃ are connected by a third dedicated FSO channel 802-3. A fourth star coupler C₄ and a fourth star decoupler S₄ are connected by a fourth dedicated FSO channel 802-4.

FIG. 8B illustrates a block diagram of a system 800-2 for a 2D-spectral/spatial FSO with induced time delay. The system 800-2 includes a plurality of star couplers (C₁, C₂, C₃, and C₄) and a plurality of star decouplers (S₁, S₂, S₃, and S₄). Coupled optical data stream generated by each start coupler Cᵢ is induced with time delay tᵢ. All optical data streams with induced time delay were then coupled by an optical coupler 804 to generate a single optical data stream. The single optical data stream was then transmitted over a FSO channel 806. From the FSO channel 806, the optical data stream was received by an optical decoupler 808. Further the time delay was added to the decoupled data stream and the star decouplers S1-S4 split the signals to recover the originally transmitted signals. This architecture significantly reduced the complexity and cost associated with deploying multiple parallel FSO links by utilizing time delay units to manage signal timing and interference.

The total CAPEX required for development of both networks can be written as follows:

$$C A P E {X}_{c} = O {C}_{K} + F S {O}_{K} + O {S}_{K} \qquad ( 11 )$$

$$CAPE {X}_{p} = O {C}_{K} + T {D}_{K} + O C + F S O + O S + T {D}_{K} + O {S}_{K} \qquad ( 12 )$$

where CAPEX_{c} represents the capital expenditure for the conventional 2D-spectral/spatial FSO system with K=4 number of optical couplers (OC), FSO links, and optical splitters (OS). Similarly, CAPEXₚ shows the total cost of implementation for the system with K=4 number of OCs, time-delay units, and OSs, along with the installation of a single OC, FSO link, and OS to facilitate the implementation of time-delay units to compensate for the use of multiple parallel FSO links.

Table 6 represents the cost of each component shown in FIG. 8A and FIG. 8B. The cost of each component for the OBAN architecture of the present disclosure and conventional architectures are used in Equations (11) and (12) to determine the cost of implementation for each component in both architectures along with the total CAPEX for the entire architecture.

TABLE 6
Cost of each component as shown in FIG. 8A and FIG. 8B.

| Sr. No | Component | Cost ($) |
|---|---|---|
| 1 | Optical combiner (1:4) | 2.5 |
| 2 | Optical splitter (1:4) | 2.5 |
| 3 | FSO module | 15 |
| 4 | Time delay units | 2 |

TABLE 7
CAPEX required for installation of each
component of FIG. 8A and FIG. 8B.

| Sr. No | Component | CAPEX_{c} ($) | CAPEXₚ ($) |
|---|---|---|---|
| 1 | Optical combiner (1:4) | 10 | 12.5 |
| 2 | Optical splitter (1:4) | 10 | 12.5 |
| 3 | FSO module | 60 | 15 |
| 4 | Time delay units | 0 | 16 |

Table 7 shows the CAPEX required for the installation of each component in both architectures. The same analysis was performed for networks with a total of sixteen nodes and with K1=4 and K2=4. It can be observed that a significant difference exists between the cost of implementing FSO links in the two architectures. This difference can be attributed to the described architecture having a reduced number of parallel FSO links, specifically, a single link, and the introduction of time-delay units with a relatively lower cost in comparison to the additional FSO links. Similarly, the addition of extra components in the OBAN architecture of the present disclosure for the implementation of time-delay units has only a minuscule effect on the cost of each component, as all of these components are relatively low in cost.

Table 8 shows a comparison of the total CAPEX for the 2D-spectral/spatial FSO systems of the present disclosure and the conventional FSO systems. The data shows that the OBAN architecture of the present disclosure significantly reduces the cost of implementation in comparison with the conventional architecture. It is evident that the utilization of low-cost time-delay units facilitates the implementation of a single FSO link to carry all traffic between the transmitter and receiver modules, unlike the conventional architecture, which requires K=4 FSO links to avoid interference between repeated codes. Consequently, the OBAN architecture of the present disclosure is more efficient in terms of CAPEX compared to the conventional architecture. The important results and techniques of this work were compared with the results and techniques of similar past studies.

TABLE 8
Comparison of the total CAPEX for the
proposed and conventional architectures

| Sr. No | Architecture | CAPEX ($) |
|---|---|---|
| 1 | Conventional | 80 |
| 2 | Disclosure | 60 |

Table 9 shows a thorough comparison between the described work and past works. It is evident from Table 9 that the OBAN architecture of the present disclosure outperforms conventional architectures in terms of flexibility, performance, security, compatibility with GR trends, and the recent recommendations of the IEEE 802.15.6 Task Group on future BANs.

TABLE 9
Comparison between the disclosure work and conventional technologies.

| Study | Sensors | Range | | Link | Code | BER |
|---|---|---|---|---|---|---|
| Mirza, J.; Ghafoor, S.; Ahmad, W.; | 4 | 0.5 | km | IR, | SAC | 10⁻⁹ |
| Salman, A.; Qureshi, K. K. | | | | extra-body | | |
| Integrating ultra-wideband and free | | | | | | |
| space optical communication for | | | | | | |
| realizing a secure and high- | | | | | | |
| throughput body area network | | | | | | |
| architecture based on optical code | | | | | | |
| division multiple access. Opt. Rev. | | | | | | |
| 2021, 28, 525-537 | | | | | | |
| Dhatchayeny, D. R.; Chung, Y. H. | 5 | 8 | m | VLC, | Un- | 10⁻⁴ |
| Optical extra-body communication | | | | extra-body | coded | |
| using smartphone cameras for | | | | | | |
| human vital sign transmission. | | | | | | |
| Appl. Opt. 2019, 58, 3995-3999 | | | | | | |
| Haddad, O.; Khalighi, M.-A.; | 1 | 5 | m | VLC, | Un- | 10⁻³ |
| Zvanovec, S. Performance analysis | | | | extra-body | coded | |
| of optical extra-WBAN links based | | | | | | |
| on realistic user mobility modeling. | | | | | | |
| Opt. Eng. 2022, 61, 026113 | | | | | | |
| Dhatchayeny, D. R.; Cahyadi, | 4 | 2 | m | VLC, | Walsh | 10⁻⁶ |
| W. A.; Teli, S. R.; Chung, Y.-H. A | | | | extra-body | code | |
| novel optical body area network | | | | | | |
| for transmission of multiple patient | | | | | | |
| vital signs. In Proceedings of the | | | | | | |
| IEEE International Conference on | | | | | | |
| Ubiquitous and Future Networks | | | | | | |
| (ICUFN), Milan, Italy, 4-7 Jul. | | | | | | |
| 2017; pp. 542-544 | | | | | | |
| Dhatchayeny, D. R.; Arya, S.; | 2 | 1.3 | m | VLC, | Walsh | 10⁻⁶ |
| Chung, Y. H. Patient mobility | | | | extra-body | code | |
| support for indoor non-directed | | | | | | |
| optical body area networks. | | | | | | |
| Sensors 2019, 19, 2297-2310 | | | | | | |
| Hasan, H. J.; Khalighi, M. A.; | 4 | 8 | m | VLC, | BPPM | 10⁻³ |
| García-Marquez, J.; Bechadergue, B. | | | | extra-body | | |
| Performance analysis of optical- | | | | | | |
| CDMA for uplink transmission in | | | | | | |
| medical extra-WBANs. IEEE | | | | | | |
| Access 2020, 8, 171672-171685 | | | | | | |
| OBAN of the present disclosure | 8 | 1-2.75 | km | IR, | 2D | 10⁻⁹ |
| | | | | extra-body | DW-7CC | |

In the present disclosure, a flexible and secure optical body area network (OBAN) based on free space optics (FSO) wireless technology and a time-delayed two-dimensional spectral/spatial optical code-division multiple access (OCDMA) system is demonstrated using numerical simulations. The setup comprises eight sensors mounted on the bodies of patients that record their vital physiological data. The data from each sensor are secured using two-dimensional double-weighted zero-cross correlation codes. After spectral/spatial encoding, the data from each signal are time-delayed, and the combined optical signal is transmitted over an FSO channel with a range of 1 km towards the medical center. The data from each sensor are decoded and recovered after photodetection at the medical center for further analysis by the medical staff.

The performance of the sensors was analyzed using bit error rate (BER) and quality factor (Q-factor) plots for different weather conditions while considering a log-normal channel. The effect of variations in the receiver aperture diameter and beam divergence on the BER and Q-factor of the received signals was also evaluated. Secure and error-free transmission of sensor data between the transmitter and the remote medical center was successfully achieved under different weather conditions.

The capital expenditure (CAPEX) of the described architecture was analyzed and compared with a conventional 2D-spectral/spatial FSO system to determine the overall impact of introducing time-delay units on the cost of implementation. The described architecture is flexible, cost-efficient, secure, and compatible with the green radio trend, while fulfilling the recent recommendations of the IEEE 802.15.6 Task Group on future body area networks (BANs).

The first embodiment is illustrated with respect to FIG. 1 to FIG. 8B. The first embodiment describes an optical body area network (OBAN) 100. The OBAN 100 includes a plurality of on-body optical sensors (K₁, K₂, . . . K₈). Each on-body optical sensor 104 is configured to generate optical signals based on a measurement by the respective on-body optical sensor. The OBAN 100 further includes an optical coordinator 106 configured to receive the optical signals from each on-body optical sensor (K₁), spectrally and spatially encode the optical signals according to a two-dimensional (2D) spectral/spatial double weight zero cross-correlation code, apply an encoded time delay to the spectrally and spatially encoded optical signals, combine the encoded time-delayed spectrally and spatially encoded optical signals into a single optical data stream, and amplify the single optical data stream. The OBAN 100 further includes a transmitter telescope 108 configured to receive the amplified single optical data stream and transmit the amplified single optical data stream over a Free Space Optical channel (FSO Channel 110). The OBAN 100 further includes a receiver telescope 114 configured to receive the amplified single optical data stream. The OBAN 100 further includes an optical decoder 218 configured to split the received amplified single optical data stream into four equal received data streams, apply a decoded time delay to each of the four equal received optical data streams, spatially and spectrally decode the four decoded time-delayed equal received optical data streams according to a 2D spatial/spectral double weight zero cross-correlation decode sequence, and generate eight decoded optical signals. The OBAN 100 further includes a low-pass filter configured to low-pass filter the eight decoded optical signals, and a bit error rate (BER) estimator BERᵢ configured to perform a BER measurement on each of the eight decoded optical signals.

In one aspect, the optical coordinator 106 includes a spectral encoder 204. The spectral encoder 204 includes a plurality of continuous wave lasers Lᵢ (L₁, L₂, . . . L₈). Each continuous wave laser is configured to generate an optical data stream based on the received optical signals. The spectral encoder 204 further includes a plurality of power splitters Sᵢ (S₁, S₂, . . . S₈), each configured to split each of the optical data streams into two equal length optical data streams. The spectral encoder 204 further includes a plurality of optical combiners OCᵢ (OC₁, OC₂, . . . OC₈), configured to combine one of the two equal length optical data streams with one of the two equal length optical data streams from a different power splitter and generate a combined data stream. Each combined data stream is a unique combination of equal length optical data streams. The spectral encoder 204 includes a plurality of Mach-Zehnder modulators Mᵢ (M₁, M₂, . . . M₈). Each of the MZM (Mᵢ) is connected to a respective optical combiner (OCᵢ). Each MZM (Mᵢ) is configured to spectrally encode the combined data stream according to the 2D spectral/spatial double weight zero cross-correlation code and split the respective encoded combined data stream into two equal spectrally encoded data streams.

In one aspect, the continuous wave lasers (Lᵢ) have wavelength values (λ₁) centered at λ₁=1552.5 nm, λ₂=1551.7 nm, λ₃=1550.9 nm, λ₄=1550.1 nm, λ₅=1549.3 nm, λ₆=1548.5 nm, λ₇=1547.7 nm, and λ₈=1546.9 nm.

In one aspect, the optical coordinator 106 further includes a plurality of pseudo-random bit sequence generators (PRBS) Pᵢ, i=1, . . . , K, and a plurality of non-return to zero pulse generators (NRZ) Nᵢ, i=1, . . . , K. Each non-return to zero pulse generator (Nᵢ) is connected to an output terminal of one of the pseudo-random bit sequence generators (Pᵢ). Each Mach-Zehnder modulator (Mᵢ) is configured with an input terminal connected to an output terminal of one of the plurality of non-return to zero pulse generators (Nᵢ).

In one aspect, the optical coordinator 106 further includes a spatial encoder 206. The spatial encoder 206 includes a first star coupler (C₁), a second star coupler (C₂), a third star coupler (C₃), and a fourth star coupler (C₄). The first star coupler (C₁) is configured to combine a first one of the two equal data streams from each Mach-Zehnder modulator (Mᵢ) for (i=1, . . . , K/2) and generate a first spectrally encoded data stream. The second star coupler (C₂) is configured to combine a second one of the two equal data streams from each Mach-Zehnder modulator (Mᵢ) for (i=1, . . . , K/2) and generate a second spectrally encoded data stream. The third star coupler (C₃) is configured to combine a first one of the two equal data streams from each Mach-Zehnder modulator (Mᵢ) for (i=K/2+1, . . . , K) and generate a third spectrally encoded data stream. The fourth star coupler (C₄) is configured to combine a second one of the two equal data streams from each Mach-Zehnder modulator (Mᵢ) for (i=K/2+1, . . . , K) and generate a fourth spectrally encoded data stream.

In one aspect, the optical coordinator 106 further includes a first spatially encoding time delay unit (t₁) configured to receive the first spectrally encoded data stream from the first star coupler (C₁), apply a first encoded time delay and generate a first time-delayed spectrally and spatially encoded data stream. The optical coordinator further includes a second spatially encoding time delay unit (t₂) configured to receive the second spectrally encoded data stream from the second star coupler (C₂), apply a second encoded time delay and generate a second time-delayed spectrally and spatially encoded data stream. The optical coordinator further includes a third spatially encoding time delay unit (t₃) configured to receive the third spectrally encoded data stream from the third star coupler (C₃), apply a third encoded time delay and generate a third time-delayed spectrally and spatially encoded data stream. The optical coordinator further includes a fourth spatially encoding time delay unit (t₄) configured to receive the fourth spectrally encoded data stream from the fourth star coupler (C₄), apply a fourth time delay and generate a fourth encoded time-delayed spectrally and spatially encoded data stream. The first time delay, the second time delay, the third time delay, and the fourth time delay are based on the spectral and spatial placement of each spectrally and spatially encoded data stream in the two-dimensional (2D) spectral/spatial double weight zero cross-correlation code.

In one aspect, the optical coordinator 106 further includes an optical coupler 220 connected to each of the spatially encoding time delay units (t₁, t₂, t₃, t₄). The optical coupler 220 is configured to combine the time-delayed spectrally and spatially encoded data streams into the single optical data stream.

In one aspect, the optical coordinator 106 further includes an optical amplifier connected to the optical coupler 220. The optical amplifier is configured to generate the amplified single optical data stream.

In one aspect, the transmitter telescope 108 is connected to the optical amplifier.

In one aspect, the optical decoder 218 further includes an optical decoupler 224 connected to the receiver telescope 114. The optical decoupler 224 is configured to split the received amplified single optical data stream into four equal received data streams.

In one aspect, the optical decoder 218 further includes a spatial decoder 214. The spatial decoder 214 includes a first spatially decoding time delay unit (t₁′) configured to receive a first one of the four equal data streams, apply a first decoded time delay and generate a first time-delayed spatially decoded data stream. The spatial decoder 214 includes a second spatially decoding time delay unit (t₂′) configured to receive a second one of the four equal data streams, apply a second decoded time delay and generate a second time-delayed spatially decoded data stream. The spatial decoder 214 includes a third spatially decoding time delay unit (t₃′) configured to receive a third one of the four equal data streams, apply a third decoded time delay and generate a third time-delayed spatially decoded data stream. The spatial decoder 214 includes a fourth spatially decoding time delay unit (t₄′) configured to receive a fourth one of the four equal data streams, apply a fourth decoded time delay and generate a fourth time-delayed spatially decoded data stream. The first decoded time delay, the second decoded time delay, the third decoded time delay, and the fourth decoded time delay are based on the spectral and spatial placement of each spatially decoded data stream in the two-dimensional (2D) spectral/spatial DW-ZCC decode sequence.

In one aspect, the spatial decoder 214 further includes a first star decoupler (S₁′) configured to receive the first time-delayed spatially decoded data stream and split the first time-delayed spatially decoded data stream into a first set of four equal spatially decoded data streams. The spatial decoder 214 further includes a second star decoupler (S₂′) configured to receive the second time-delayed spatially decoded data stream and split the second time-delayed spatially decoded data stream into a second set of four equal spatially decoded data streams. The spatial decoder 214 further includes a third star decoupler (S₃′) configured to receive the third time-delayed spatially decoded data stream and split the third time-delayed spatially decoded data stream into a third set of four equal spatially decoded data streams. The spatial decoder 214 further includes a fourth star decoupler (S₄′) configured to receive the fourth time-delayed spatially decoded data stream and split the fourth time-delayed spatially decoded data stream into a fourth set of four equal spatially decoded data streams.

In one aspect, the optical decoder 218 further includes a spectral decoder 216 configured with a plurality of receiver circuits Rᵢ (R₁, R₂, . . . R₈). Each receiver circuit includes a first optical bandpass filter FBFᵢ, a second optical bandpass filter SBFᵢ, an optical coupler/splitter OSᵢ, a first photodetector FPDᵢ, a second photodetector SPDᵢ, a subtractor SUBᵢ, an electrical low-pass filter LPFᵢ, and a bit error rate (BER) analyzer BERᵢ.

In one aspect, the plurality of receiver circuits (Rᵢ) of the spectral decoder further includes a first receiver circuit (R₁). The first receiver circuit (R₁) includes the first optical bandpass filter FBFᵢ configured to receive a first one of the first set of four equal spatially decoded data streams from the first star decoupler (S₁′) and the second optical bandpass filter SBFᵢ configured to receive a first one of the second set of four equal spatially decoded data streams from the second star decoupler (S₂′). The first optical bandpass filter FBFᵢ and the second optical bandpass filter SBFᵢ are each tuned to filter the received spatially decoded data streams to the frequency λ₁=1552.5 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low-pass filter LPFᵢ is configured to receive the difference signal and generate a low-pass filtered difference signal. The bit error rate (BER) estimator BER; is configured to estimate the bit error rate (BER) of the low-pass filtered difference signal and verify signal reception when the BER is greater than or equal to 1×10⁻⁹.

The plurality of receiver circuits (Rᵢ) of the spectral decoder further includes a second receiver circuit (R₂) which includes the first optical bandpass filter FBFᵢ configured to receive a second one of the first set of four equal spatially decoded data streams from the first star decoupler (S₁′) and the second optical bandpass filter SBFᵢ configured to receive a second one of the second set of four equal spatially decoded data streams from the second star decoupler (S₂′). The first optical bandpass filter FBFᵢ and the second optical bandpass filter SBFᵢ are each tuned to filter the received spatially decoded data streams to the frequency λ₂=1551.7 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low-pass filter LPFᵢ is configured to receive the difference signal and generate a low-pass filtered difference signal. The bit error rate (BER) estimator BER; is configured to estimate the bit error rate of the low-pass filtered difference signal and verify signal reception when the BER is greater than or equal to 1×10⁻⁹.

The plurality of receiver circuits (Rᵢ) of the spectral decoder further includes a third receiver circuit (R₃) which includes the first optical bandpass filter FBFᵢ configured to receive a third one of the first set of four equal spatially decoded data streams from the first star decoupler (S₁′) and the second optical bandpass filter SBFᵢ configured to receive a third one of the second set of four equal spatially decoded data streams from the second star decoupler (S₂′). The first optical bandpass filter FBFᵢ and the second optical bandpass filter SBFᵢ are each tuned to filter the received spatially decoded data streams to the frequency λ₃=1550.9 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low-pass filter LPFᵢ is configured to receive the difference signal and generate a low-pass filtered difference signal. The bit error rate (BER) estimator BERᵢ is configured to estimate the bit error rate of the low-pass filtered difference signal and verify signal reception when the BER is greater than or equal to 1×10⁻⁹.

The plurality of receiver circuits (Rᵢ) of the spectral decoder further includes a fourth receiver circuit (R₄) which includes the first optical bandpass filter FBFᵢ configured to receive a fourth one of the first set of four equal spatially decoded data streams from the first star decoupler (S₁′) and the second optical bandpass filter SBFᵢ configured to receive a fourth one of the second set of four equal spatially decoded data streams from the second star decoupler (S₂′). The first optical bandpass filter FBFᵢ and the second optical bandpass filter SBFᵢ are each tuned to filter the received spatially decoded data streams to the frequency λ₄=1550.1 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low-pass filter LPF; is configured to receive the difference signal and generate a low-pass filtered difference signal. The bit error rate estimator BERᵢ is configured to estimate the bit error rate of the low-pass filtered difference signal and verify signal reception when the BER is greater than or equal to 1×10⁻⁹.

The plurality of receiver circuits (Rᵢ) of the spectral decoder further includes a fifth receiver circuit (R₅) which includes the first optical bandpass filter FBFᵢ configured to receive a first one of the third set of four equal spatially decoded data streams from the third star decoupler (S₃′) and the second optical bandpass filter SBFᵢ configured to receive a first one of the fourth set of four equal spatially decoded data streams from the fourth star decoupler (S₄′). The first optical bandpass filter FBFᵢ and the second optical bandpass filter SBFᵢ are each tuned to filter the received spatially decoded data streams to the frequency λ₅=1549.3 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low pass filter LPFᵢ is configured to receive the difference signal and generate a low pass filtered difference signal. The bit error rate estimator BER; is configured to estimate the bit error rate (BER) of the low pass filtered difference signal and verify signal reception when the BER is greater than or equal to 1×10⁻⁹.

The plurality of receiver circuits (Rᵢ) of the spectral decoder further includes a sixth receiver circuit (R₆) which includes the first optical bandpass filter FBFᵢ configured to receive a second one of the third set of four equal spatially decoded data streams from the third star decoupler (S₃′) and the second optical bandpass filter SBFᵢ configured to receive a second one of the fourth set of four equal spatially decoded data streams from the fourth star decoupler (S₄′). The first optical bandpass filter FBFᵢ and the second optical bandpass filter SBFᵢ are each tuned to filter the received spatially decoded data streams to the frequency λ₆=1548.5 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low pass filter LPFᵢ is configured to receive the difference signal and generate a low pass filtered difference signal. The bit error rate estimator BER; is configured to estimate the bit error rate (BER) of the low pass filtered difference signal and verify signal reception when the BER is greater than or equal to 1×10⁻⁹.

The plurality of receiver circuits (Rᵢ) of the spectral decoder further includes a seventh receiver circuit (R₇) which includes the first optical bandpass filter FBFᵢ configured to receive a third one of the third set of four equal spatially decoded data streams from the third star decoupler (S₃′) and the second optical bandpass filter SBFᵢ configured to receive a third one of the fourth set of four equal spatially decoded data streams from the fourth star decoupler (S₄′). The first optical bandpass filter FBFᵢ and the second optical bandpass filter SBFᵢ are each tuned to filter the received spatially decoded data streams to the frequency λ₇=1547.7 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low pass filter LPFᵢ is configured to receive the difference signal and generate a low pass filtered difference signal. The bit error rate estimator BERᵢ is configured to estimate the bit error rate (BER) of the low pass filtered difference signal and verify signal reception when the BER is greater than or equal to 1×10⁻⁹.

In one aspect, the plurality of receiver circuits (Rᵢ) of the spectral decoder further includes an eighth receiver circuit (R₈) which includes the first optical bandpass filter FBFᵢ configured to receive a fourth one of the third set of four equal spatially decoded data streams from the third star decoupler (S₃′) and the second optical bandpass filter SBFᵢ configured to receive a fourth one of the fourth set of four equal spatially decoded data streams from the fourth star decoupler (S₄′). The first optical bandpass filter FBFᵢ and the second optical bandpass filter SBFᵢ are each tuned to filter the received spatially decoded data streams to the frequency λ₈=1546.9 nm. The optical coupler/splitter OSᵢ is configured to combine the filtered spatially decoded data streams and split the filtered spatially decoded data streams into two equal filtered spatially decoded data streams. The first photodetector FPDᵢ is configured to generate a first electrical signal upon detecting a first of the two equal filtered spatially decoded data streams. The second photodetector SPDᵢ is configured to generate a second electrical signal upon detecting a second of the two equal filtered spatially decoded data streams. The subtractor SUBᵢ is configured to subtract the second electrical signal from the first electrical signal and generate a difference signal. The electrical low pass filter LPFᵢ is configured to receive the difference signal and generate a low pass filtered difference signal. The bit error rate estimator BER; is configured to estimate the bit error rate (BER) of the low pass filtered difference signal and verify signal reception when the BER is greater than or equal to 1×10⁻⁹.

The second embodiment is illustrated with respect to FIG. 1 to FIG. 8B. The second embodiment includes a method for transmission of optical body area network signals over a free space optical network is described. The method includes generating, by each of a plurality of on-body optical sensors Kᵢ, where i=1, 2, . . . , 8, optical signals based on a measurement by a respective on-body optical sensor, receiving, by an optical coordinator, the optical signals from each on-body optical sensor Kᵢ, and spectrally and spatially encoding, by the optical coordinator, the optical signals according to a two dimensional (2D) spectral/spatial double weight zero cross correlation code. The method further includes applying, by the optical coordinator, an encoded time delay to the spectrally and spatially encoded optical signals, combining, by an optical coupler, the encoded time delayed spectrally and spatially encoded optical signals into a single optical data stream, amplifying, by an amplifier, the single optical data stream, and receiving, by a transmitter telescope, the amplified single optical data stream. The method further includes transmitting the amplified single optical data stream over a free space optical channel, receiving, by a receiver telescope, the amplified single optical data stream, splitting, by an optical decoder, the received amplified single optical data streams into four equal received data streams, and applying, by the optical decoder, a decoding time delay to each of the four equal received optical data streams. The method further includes spatially and spectrally decoding, by the optical decoder, the four decoded time delayed equal received optical data streams according to a 2D spatial/spectral double weight zero cross correlation decode sequence, generating, by the optical decoder, eight decoded optical signals, low pass filtering, by a low pass filter, the eight decoded optical signals, performing, by a bit error rate BER estimator, a BER measurement on each of the eight decoded optical signals, and verifying, by the bit error rate BER estimator, signal reception when the BER is greater than or equal to 1×10⁻⁹.

In one aspect, the method further includes spectrally encoding, by the optical coordinator 203, the optical signals. Spectrally encoding includes generating, from each of a plurality of continuous wave lasers (CW lasers Lᵢ), where i=1, 2, . . . , K, an optical data stream based on a respective one of the received optical signals. Spectrally encoding further includes splitting, by a plurality of power splitters (Sᵢ), where i=1, 2, . . . , K, each optical data stream into two equal length optical data streams. Spectrally encoding further includes combining, by a plurality of optical combiners (OCᵢ), where i=1, 2, . . . , K, each one of the two equal length optical data streams with one of the two equal length optical data streams from a different power splitter. Spectrally encoding further includes generating, by each optical combiner (OCᵢ), a combined data stream. Each combined data stream is a unique combination of equal length optical data streams. Spectrally encoding further includes spectrally encoding, by a plurality of Mach-Zehnder modulators (Mᵢ), where i=1, 2, . . . , K, each connected to a respective optical combiner (OCᵢ), each combined data stream according to the 2D spectral/spatial double weight zero cross-correlation code, and splitting each encoded combined data stream into two equal spectrally encoded data streams.

In one aspect, spatially encoding each of the two equal spectrally encoded data streams includes combining, by a first star coupler (C₁), a first one of the two equal data streams from each Mach-Zehnder modulator (Mᵢ) for i=1, . . . , K/2. The method further includes generating, by the first star coupler (C₁), a first spectrally encoded data stream. The method further includes combining, by a second star coupler (C₂), a second one of the two equal data streams from each Mach-Zehnder modulator (Mᵢ). The method further includes generating, by the second star coupler (C₂), a second spectrally encoded data stream. The method further comprises combining, by a third star coupler (C₃), a third one of the two equal data streams from each Mach-Zehnder modulator (Mᵢ). The method further includes generating, by the third star coupler (C₃), a third spectrally encoded data stream. The method further includes combining, by a fourth star coupler (C₄), a fourth one of the two equal data streams from each Mach-Zehnder modulator (Mᵢ). The method further includes generating, by the fourth star coupler (C₄), a fourth spectrally encoded data stream.

In one aspect, applying a time delay to each spectrally encoded data stream includes receiving, by a first spatially encoding time delay unit (t₁), the first spectrally encoded data stream from the first star coupler (C₁). The method further includes applying a first encoded time delay and generating a first time delayed spectrally and spatially encoded data stream. The method further includes receiving, by a second spatially encoding time delay unit (t₂), the second spectrally encoded data stream from the second star coupler (C₂). The method further includes applying a second encoded time delay and generating a second time delayed spectrally and spatially encoded data stream. The method further includes receiving, by a third spatially encoding time delay unit (t₃), the third spectrally encoded data stream from the third star coupler (C₃). The method further includes applying a third encoded time delay and generating a third time delayed spectrally and spatially encoded data stream. The method further includes receiving, by a fourth spatially encoding time delay unit (t₄), the fourth spectrally encoded data stream from the fourth star coupler (C₄). The method further includes applying a fourth encoded time delay and generating a fourth time delayed spectrally and spatially encoded data stream. The first time delay, the second time delay, the third time delay and the fourth time delay are based on the spectral and spatial placement of each spectrally and spatially encoded data stream in the two-dimensional (2D) spectral/spatial double weight zero cross-correlation code. The method further includes combining, by an optical coupler 220, connected to each of the spatially encoding time delay units, the time delayed spectrally and spatially encoded data streams into the single optical data stream. The method further includes generating, by an optical amplifier connected to the optical coupler, the amplified single optical data stream.

In one aspect, the method further includes splitting, by an optical decoupler 224 connected to the receiver telescope 114, the received amplified single optical data stream into four equal received data streams. The method further includes spatially decoding the four equal received data streams by receiving, by a first spatially decoding time delay unit (t₁′), a first one of the four equal data streams. The method further comprises applying a first decoded time delay and generating a first time delayed spatially decoded data stream. The method further includes receiving, by a second spatially decoding time delay unit (t₂′), a second one of the four equal data streams. The method further comprises applying a second decoded time delay and generating a second time delayed spatially decoded data stream. The method further includes receiving, by a third spatially decoding time delay unit (t₃′), a third one of the four equal data streams. The method further comprises applying a third decoded time delay and generating a third time delayed spatially decoded data stream. The method further includes receiving, by a fourth spatially decoding time delay unit (t₄′), a fourth one of the four equal data streams. The method further includes applying a fourth decoded time delay and generating a fourth time delayed spatially decoded data stream. The first decoded time delay, the second decoded time delay, the third decoded time delay and the fourth decoded time delay are based on the spectral and spatial placement of each spatially decoded data stream in the two-dimensional spectral/spatial double weight zero cross-correlation decode sequence. The method further includes receiving, by a first star decoupler S₁′, the first time delayed spatially decoded data stream, and splitting the first time delayed spatially decoded data stream into a first set of four equal spatially decoded data streams. The method further includes receiving, by a second star decoupler S₂′, the second time delayed spatially decoded data stream, and splitting the second time delayed spatially decoded data stream into a second set of four equal spatially decoded data streams. The method further includes receiving, by a third star decoupler S₃′, the third time delayed spatially decoded data stream, and splitting the third time delayed spatially decoded data stream into a third set of four equal spatially decoded data streams. The method further includes splitting, by a fourth star decoupler S₄′, the fourth time delayed spatially decoded data stream and splitting the fourth time delayed spatially decoded data stream into a fourth set of four equal spatially decoded data streams.

In one aspect, the method further includes spectrally decoding the first set of four equal spatially decoded data streams, the second set of four equal spatially decoded data streams, the third set of four equal spatially decoded data streams, and the fourth set of four equal spatially decoded data streams. The method includes receiving, by a first optical bandpass filter FBFᵢ of a first receiver circuit R₁, a first one of the first set of four equal spatially decoded data streams from the first star decoupler S₁′. The method further includes receiving, by a second optical bandpass filter SBFᵢ of the first receiver circuit R₁, a first one of the second set of four equal spatially decoded data streams from the second star decoupler S₂′. The method further includes filtering, by the first optical bandpass filter FBFᵢ and the second optical bandpass filter SBFᵢ of the first receiver circuit R₁, the received spatially decoded data streams to a frequency λ₁=1552.5 nm. The method further includes combining, by an optical coupler/splitter OSᵢ of the first receiver circuit R₁, the filtered spatially decoded data streams. The method further includes splitting, by the optical coupler/splitter OSᵢ of the first receiver circuit R₁, the filtered spatially decoded data streams into two equal filtered spatially decoded data streams. The method further includes generating, by a first photodetector FPDᵢ of the first receiver circuit R₁, a first electrical signal upon detecting a first of the two equal filtered spatially decoded data streams. The method further includes generating, by a second photodetector SPDᵢ of the first receiver circuit R₁, a second electrical signal upon detecting a second of the two equal filtered spatially decoded data streams. The method further includes subtracting, by a subtractor SUBᵢ of the first receiver circuit R₁, the second electrical signal from the first electrical signal and generating a difference signal. The method further includes low pass filtering, by an electrical low pass filter LPFᵢ of the first receiver circuit R₁, the difference signal and generating a low pass filtered difference signal. The method further includes estimating, by a bit error rate estimator BERᵢ of the first receiver circuit R₁, a bit error rate (BER) of the low pass filtered difference signal and verifying signal reception when the BER is greater than or equal to 1×10⁻⁹.

The method further includes receiving, by a first optical bandpass filter of a second receiver circuit R₂, a second one of the first set of four equal spatially decoded data streams from the first star decoupler S₁′. The method further includes receiving, by a second optical bandpass filter of the second receiver circuit R₂, a second one of the second set of four equal spatially decoded data streams from the second star decoupler S₂′. The method further includes filtering, by the first optical bandpass filter and the second optical bandpass filter of the second receiver circuit R₂, the received spatially decoded data streams to a frequency λ₂=1551.7 nm. The method further includes combining, by an optical coupler/splitter of the second receiver circuit R₂, the filtered spatially decoded data streams. The method further includes splitting, by the optical coupler/splitter of the second receiver circuit R₂, the filtered spatially decoded data streams into two equal filtered spatially decoded data streams. The method further includes generating, by a first photodetector of the second receiver circuit R₂, a first electrical signal upon detecting a first of the two equal filtered spatially decoded data streams. The method further includes generating, by a second photodetector of the second receiver circuit R₂, a second electrical signal upon detecting a second of the two equal filtered spatially decoded data streams. The method further includes subtracting, by a subtractor of the second receiver circuit R₂, the second electrical signal from the first electrical signal and generating a difference signal. The method further includes low pass filtering, by an electrical low pass filter of the second receiver circuit R₂, the difference signal and generating a low pass filtered difference signal. The method further includes estimating, by a bit error rate estimator of the second receiver circuit R₂, a bit error rate of the low pass filtered difference signal and verifying signal reception when the BER is greater than or equal to 1×10⁻⁹.

The method further includes receiving, by a first optical bandpass filter of a third receiver circuit R₃, a third one of the first set of four equal spatially decoded data streams from the first star decoupler S₁′. The method further includes receiving, by a second optical bandpass filter of the third receiver circuit R₃, a third one of the second set of four equal spatially decoded data streams from the second star decoupler S₂′. The method further includes filtering, by the first optical bandpass filter and the second optical bandpass filter of the third receiver circuit R₃, the received spatially decoded data streams to the frequency λ₃=1550.9 nm. The method further includes combining, by an optical coupler/splitter of the third receiver circuit R₃, the filtered spatially decoded data streams. The method further includes splitting, by the optical coupler/splitter of the third receiver circuit R₃, the filtered spatially decoded data streams into two equal filtered spatially decoded data streams. The method further includes generating, by a first photodetector of the third receiver circuit R₃, a first electrical signal upon detecting a first of the two equal filtered spatially decoded data streams. The method further includes generating, by a second photodetector of the third receiver circuit R₃, a second electrical signal upon detecting a second of the two equal filtered spatially decoded data streams. The method further includes subtracting, by a subtractor of the third receiver circuit R₃, the second electrical signal from the first electrical signal and generating a difference signal. The method further includes low pass filtering, by an electrical low pass filter of the third receiver circuit R₃, the difference signal and generating a low pass filtered difference signal. The method further includes estimating, by a bit error rate estimator of the third receiver circuit R₃, a bit error rate of the low pass filtered difference signal and verifying signal reception when the BER is greater than or equal to 1×10⁻⁹.

The method further comprises receiving, by a first optical bandpass filter of a fourth receiver circuit R₄, a fourth one of the first set of four equal spatially decoded data streams from the first star decoupler S₁′. The method further includes receiving, by a second optical bandpass filter of the fourth receiver circuit R₄, a fourth one of the second set of four equal spatially decoded data streams from the second star decoupler S₂′. The method further includes filtering, by the first optical bandpass filter and the second optical bandpass filter of the fourth receiver circuit R₄, the received spatially decoded data streams to a frequency λ₄=1550.1 nm. The method further includes combining, by an optical coupler/splitter of the fourth receiver circuit R₄, the filtered spatially decoded data streams. The method further includes splitting, by the optical coupler/splitter of the fourth receiver circuit R₄, the filtered spatially decoded data streams into two equal filtered spatially decoded data streams. The method further includes generating, by a first photodetector of the fourth receiver circuit R₄, a first electrical signal upon detecting a first of the two equal filtered spatially decoded data streams. The method further includes generating, by a second photodetector of the fourth receiver circuit R₄, a second electrical signal upon detecting a second of the two equal filtered spatially decoded data streams. The method further includes subtracting, by a subtractor of the fourth receiver circuit R₄, the second electrical signal from the first electrical signal and generating a difference signal. The method further includes low pass filtering, by an electrical low pass filter of the fourth receiver circuit R₄, the difference signal and generating a low pass filtered difference signal. The method further includes estimating, by a bit error rate estimator of the fourth receiver circuit R₄, a bit error rate of the low pass filtered difference signal and verifying signal reception when the BER is greater than or equal to 1×10⁻⁹.

The method further comprises receiving, by a first optical bandpass filter of a fifth receiver circuit R₅, a first one of the third set of four equal spatially decoded data streams from the third star decoupler S₃′. The method further includes receiving, by a second optical bandpass filter of the fifth receiver circuit R₅, a first one of the fourth set of four equal spatially decoded data streams from the fourth star decoupler S₄′. The method further includes filtering, by the first optical bandpass filter and the second optical bandpass filter of the fifth receiver circuit R₅, the received spatially decoded data streams to the frequency λ₅=1549.3 nm. The method further includes combining, by an optical coupler/splitter of the fifth receiver circuit R₅, the filtered spatially decoded data streams. The method further includes splitting, by the optical coupler/splitter of the fifth receiver circuit R₅, the filtered spatially decoded data streams into two equal filtered spatially decoded data streams. The method further includes generating, by a first photodetector of the fifth receiver circuit R₅, a first electrical signal upon detecting a first of the two equal filtered spatially decoded data streams. The method further includes generating, by a second photodetector of the fifth receiver circuit R₅, a second electrical signal upon detecting a second of the two equal filtered spatially decoded data streams. The method further includes subtracting, by a subtractor of the fifth receiver circuit R₅, the second electrical signal from the first electrical signal and generating a difference signal. The method further includes low pass filtering, by an electrical low pass filter of the fifth receiver circuit R₅, the difference signal and generating a low pass filtered difference signal. The method further includes estimating, by a bit error rate estimator of the fifth receiver circuit R₅, a bit error rate of the low pass filtered difference signal and verifying signal reception when the BER is greater than or equal to 1×10⁻⁹.

The method further comprises receiving, by a first optical bandpass filter of a sixth receiver circuit R₆, a second one of the third set of four equal spatially decoded data streams from the third star decoupler S₃′. The method further includes receiving, by a second optical bandpass filter of the sixth receiver circuit R₆, a second one of the fourth set of four equal spatially decoded data streams from the fourth star decoupler S₄′. The method further includes filtering, by the first optical bandpass filter and the second optical bandpass filter of the sixth receiver circuit R₆, the received spatially decoded data streams to the frequency λ₆=1548.5 nm. The method further includes combining, by an optical coupler/splitter of the sixth receiver circuit R₆, the filtered spatially decoded data streams. The method further includes splitting, by the optical coupler/splitter of the sixth receiver circuit R₆, the filtered spatially decoded data streams into two equal filtered spatially decoded data streams. The method further includes generating, by a first photodetector of the sixth receiver circuit R₆, a first electrical signal upon detecting a first of the two equal filtered spatially decoded data streams. The method further includes generating, by a second photodetector of the sixth receiver circuit R₆, a second electrical signal upon detecting a second of the two equal filtered spatially decoded data streams. The method further includes subtracting, by a subtractor of the sixth receiver circuit R₆, the second electrical signal from the first electrical signal and generating a difference signal. The method further includes low pass filtering, by an electrical low pass filter of the sixth receiver circuit R₆, the difference signal and generating a low pass filtered difference signal. The method further includes estimating, by a bit error rate estimator of the sixth receiver circuit R₆, a bit error rate of the low pass filtered difference signal and verifying signal reception when the BER is greater than or equal to 1×10⁻⁹.

The method further comprises receiving, by a first optical bandpass filter of a seventh receiver circuit R₇, a third one of the third set of four equal spatially decoded data streams from the third star decoupler S₃′. The method further includes receiving, by a second optical bandpass filter of the seventh receiver circuit R₇, a third one of the fourth set of four equal spatially decoded data streams from the fourth star decoupler S₄′. The method further includes filtering, by the first optical bandpass filter and the second optical bandpass filter of the seventh receiver circuit R₇, the received spatially decoded data streams to a frequency λ₇=1547.7 nm. The method further includes combining, by an optical coupler/splitter of the seventh receiver circuit R₇, the filtered spatially decoded data streams. The method further includes splitting, by the optical coupler/splitter of the seventh receiver circuit R₇, the filtered spatially decoded data streams into two equal filtered spatially decoded data streams. The method further includes generating, by a first photodetector of the seventh receiver circuit R₇, a first electrical signal upon detecting a first of the two equal filtered spatially decoded data streams. The method further includes generating, by a second photodetector of the seventh receiver circuit R₇, a second electrical signal upon detecting a second of the two equal filtered spatially decoded data streams. The method further includes subtracting, by a subtractor of the seventh receiver circuit R₇, the second electrical signal from the first electrical signal and generating a difference signal. The method further includes low pass filtering, by an electrical low pass filter of the seventh receiver circuit R₇, the difference signal and generating a low pass filtered difference signal. The method further includes estimating, by a bit error rate estimator of the seventh receiver circuit R₇, a bit error rate of the low pass filtered difference signal and verifying signal reception when the BER is greater than or equal to 1×10⁻⁹.

The method further comprises receiving, by a first optical bandpass filter of an eighth receiver circuit R₈, a fourth one of the third set of four equal spatially decoded data streams from the third star decoupler S₃′. The method further includes receiving, by a second optical bandpass filter of the eighth receiver circuit R₈, a fourth one of the fourth set of four equal spatially decoded data streams from the fourth star decoupler S₄′. The method further includes filtering, by the first optical bandpass filter and the second optical bandpass filter of the eighth receiver circuit R₈, the received spatially decoded data streams to a frequency λ₈=1546.9 nm. The method further includes combining, by an optical coupler/splitter of the eighth receiver circuit R₈, the filtered spatially decoded data streams. The method further includes splitting, by the optical coupler/splitter of the eighth receiver circuit R₈, the filtered spatially decoded data streams into two equal filtered spatially decoded data streams. The method further includes generating, by a first photodetector of the eighth receiver circuit R₈, a first electrical signal upon detecting a first of the two equal filtered spatially decoded data streams. The method further includes generating, by a second photodetector of the eighth receiver circuit R₈, a second electrical signal upon detecting a second of the two equal filtered spatially decoded data streams. The method further includes subtracting, by a subtractor of the eighth receiver circuit R₈, the second electrical signal from the first electrical signal and generating a difference signal. The method further includes low pass filtering, by an electrical low pass filter of the eighth receiver circuit R₈, the difference signal and generating a low pass filtered difference signal. The method further includes estimating, by a bit error rate estimator of the eighth receiver circuit R₈, a bit error rate of the low pass filtered difference signal and verifying signal reception when the BER is greater than or equal to 1×10⁻⁹.

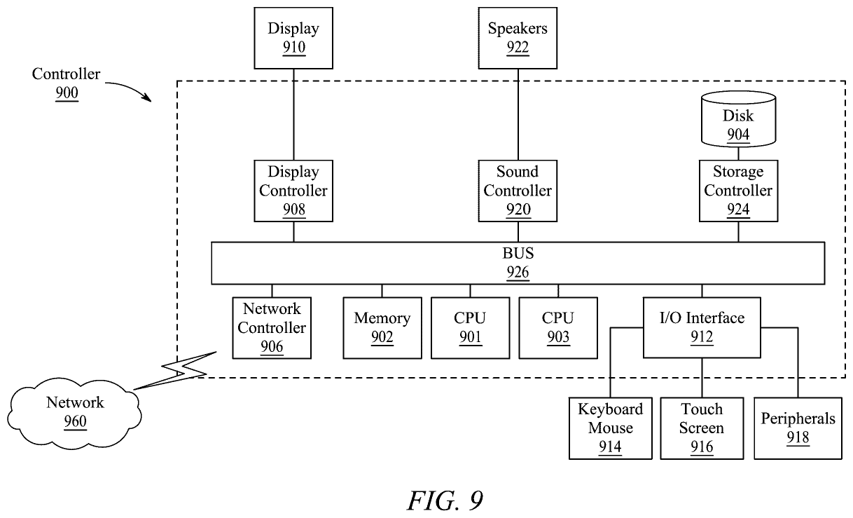

Next, further details of the hardware description of the computing environment according to exemplary embodiments is described with reference to FIG. 9. In FIG. 9, a controller 900 as described is representative of the OBAN 200 of FIG. 2 in which the controller is a computing device which includes a CPU 901 which performs the processes described above/below. The process data and instructions may be stored in memory 902. These processes and instructions may also be stored on a storage medium disk 904 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 901, 903 and an operating system such as Microsoft Windows 7, Microsoft Windows 10, Microsoft Windows 11,UNIX, Solaris, LINUX, Apple MAC-OS and other systems known to those skilled in the art.

The hardware elements in order to achieve the computing device may be realized by various circuitry elements, known to those skilled in the art. For example, CPU 901 or CPU 903 may be a Xenon or Core processor from Intel of America or an Opteron processor from AMD of America, or may be other processor types that would be recognized by one of ordinary skill in the art. Alternatively, the CPU 901, 903 may be implemented on an FPGA, ASIC, PLD or using discrete logic circuits, as one of ordinary skill in the art would recognize. Further, CPU 901, 903 may be implemented as multiple processors cooperatively working in parallel to perform the instructions of the inventive processes described above.

The computing device in FIG. 9 also includes a network controller 906, such as an Intel Ethernet PRO network interface card from Intel Corporation of America, for interfacing with network 960.

As can be appreciated, the communication system 960 can utilize free space optical (FSO) technology for data transmission. The FSO communication system 960 can be implemented in various network configurations, such as point-to-point, point-to-multipoint, or mesh networks. The FSO communication system 960 can operate over long distances, typically ranging from a few meters to several kilometers, depending on environmental conditions and the specific requirements of the application.

The FSO communication system 960 can provide high bandwidth and secure data transmission by using light beams to transmit data through free space. The FSO technology can be employed in various scenarios, including urban environments, inter-building communications, last-mile access, and backhaul for wireless networks. The FSO communication system 960 can operate in conjunction with other communication technologies, such as microwave, fiber optics, and satellite communication systems to enhance network reliability and performance.

The FSO communication system 960 can include adaptive optics and tracking mechanisms to maintain alignment between the transmitter and receiver, ensuring robust data transmission even in adverse weather conditions. Additionally, the FSO communication system 960 can incorporate error correction and encryption techniques to ensure data integrity and security.

The computing device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

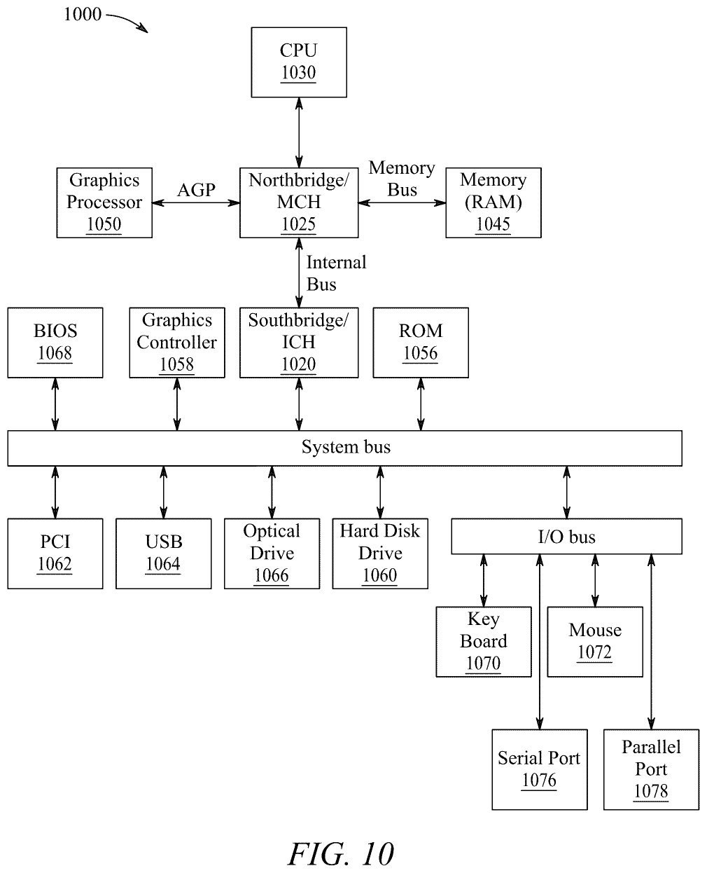

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 10.

FIG. 10 shows a schematic diagram of a data processing system, according to certain embodiments, for performing the functions of the exemplary embodiments. The data processing system is an example of a computer in which code or instructions implementing the processes of the illustrative embodiments may be located.

In FIG. 10, data processing system 1000 employs a hub architecture including a north bridge and memory controller hub (NB/MCH) 1025 and a south bridge and input/output (I/O) controller hub (SB/ICH) 1020. The central processing unit (CPU) 1030 is connected to NB/MCH 1025. The NB/MCH 1025 also connects to the memory 1045 via a memory bus, and connects to the graphics processor 1050 via an accelerated graphics port (AGP). The NB/MCH 1025 also connects to the SB/ICH 1020 via an internal bus (e.g., a unified media interface or a direct media interface). The CPU Processing unit 1030 may contain one or more processors and even may be implemented using one or more heterogeneous processor systems.

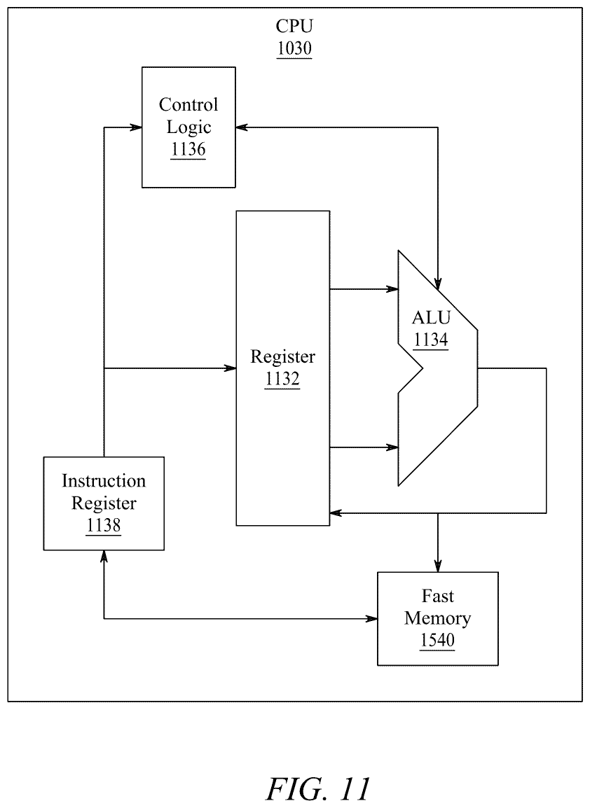

For example, FIG. 11 shows one implementation of CPU 1030. In one implementation, the instruction register 1138 retrieves instructions from the fast memory 1140. At least part of these instructions is fetched from the instruction register 1138 by the control logic 1136 and interpreted according to the instruction set architecture of the CPU 1030. Part of the instructions can also be directed to the register 1132. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1134 that loads values from the register 1132 and performs logical and mathematical operations on the loaded values according to the instructions. The results from these operations can be feedback into the register and/or stored in the fast memory 1140. According to certain implementations, the instruction set architecture of the CPU 1030 can use a reduced instruction set architecture, a complex instruction set architecture, a vector processor architecture, a very large instruction word architecture. Furthermore, the CPU 1030 can be based on the Von Neuman model or the Harvard model. The CPU 1030 can be a digital signal processor, an FPGA, an ASIC, a PLA, a PLD, or a CPLD. Further, the CPU 1030 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 10, the data processing system 1000 can include that the SB/ICH 1020 is coupled through a system bus to an I/O Bus, a read only memory (ROM) 1056, universal serial bus (USB) port 1064, a flash binary input/output system (BIOS) 1068, and a graphics controller 1058. PCI/PCIe devices can also be coupled to SB/ICH 1088 through a PCI bus 1062.

The PCI devices may include, for example, Ethernet adapters, add-in cards, and PC cards for notebook computers. The Hard disk drive 1060 and CD-ROM 1066 can use, for example, an integrated drive electronics (IDE) or serial advanced technology attachment (SATA) interface. In one implementation the I/O bus can include a super I/O (SIO) device.

Further, the hard disk drive (HDD) 1060 and optical drive 1066 can also be coupled to the SB/ICH 1020 through a system bus. In one implementation, a keyboard 1070, a mouse 1072, a parallel port 1078, and a serial port 1076 can be connected to the system bus through the I/O bus. Other peripherals and devices that can be connected to the SB/ICH 1020 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

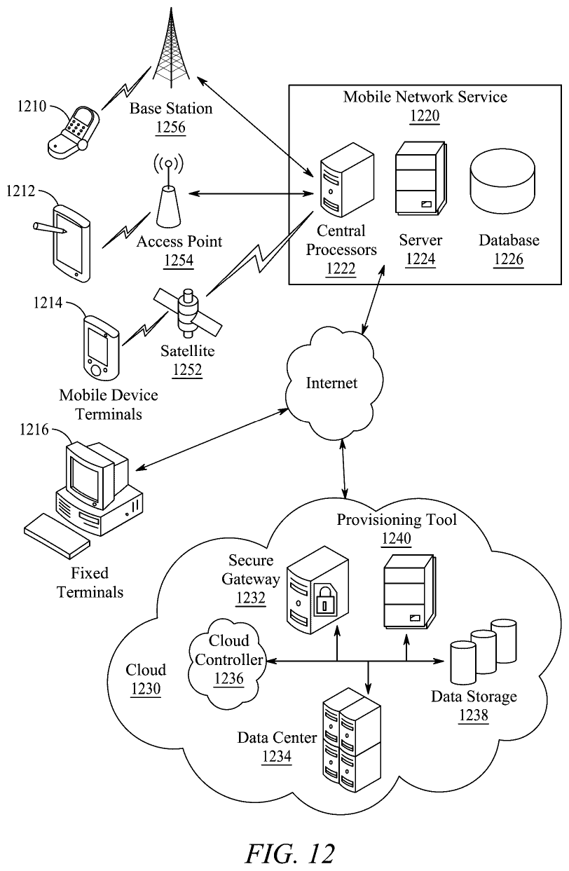

The functions and features described herein may also be executed by various distributed components of a system. For example, one or more processors may execute these system functions, wherein the processors are distributed across multiple components communicating in a network. The distributed components may include one or more client and server machines, such as cloud 1030 including a cloud controller 1036, a secure gateway 1032, a data center 1034, data storage 1038 and a provisioning tool 1040, and mobile network services 1020 including central processors 1022, a server 1024 and a database 1026, which may share processing, as shown by FIG. 12, in addition to various human interface and communication devices (e.g., display monitors 1016, smart phones 1010, tablets 1012, personal digital assistants (PDAs) 1014). The network may be a private network, such as a LAN, satellite 1052 or WAN 1054, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An optical body area network, comprising:
a plurality of on-body optical sensors Kᵢ, where i=1, 2, . . . , 8, wherein each on-body optical sensor is configured to generate optical signals based on a measurement by the respective on-body optical sensor;
an optical coordinator configured to receive the optical signals from each on-body optical sensor Kᵢ, spectrally and spatially encode the optical signals according to a two dimensional (2D) spectral/spatial double weight zero cross correlation code, apply an encoded time delay to the spectrally and spatially encoded optical signals, combine the encoded time delayed spectrally and spatially encoded optical signals into a single optical data stream, and amplify the single optical data stream;
a transmitter telescope configured to receive the amplified single optical data stream and transmit the amplified single optical data stream over a free space optical channel;
a receiver telescope configured to receive the amplified single optical data stream;
an optical decoder configured to split the received amplified single optical data streams into four equal received data streams, apply a decoded time delay to each of the four equal received optical data streams, spatially and spectrally decode the four decoded time delayed equal received optical data streams according to a 2D spatial/spectral double weight zero cross correlation decode sequence, and generate eight decoded optical signals;
a low pass filter configured to low pass filter the eight decoded optical signals; and
a bit error rate BER estimator configured to perform a BER measurement on each of the eight decoded optical signals.

2. The optical body area network of claim 1, wherein the optical coordinator comprises:
a spectral encoder which includes:
a plurality of continuous wave lasers Lᵢ, where i=1, 2, . . . , K, each configured to generate an optical data stream based on the received optical signals;
a plurality of power splitters Sᵢ, where i=1, 2, . . . , K, each configured to split each of the optical data streams into two equal length optical data streams;
a plurality of optical combiners OCᵢ, where i=1, 2, . . . , K, each configured to combine one of the two equal length optical data streams with one of the two equal length optical data streams from a different power splitter and generate a combined data stream, wherein each combined data stream is a unique combination of equal length optical data streams; and
a plurality of Mach-Zehnder modulators Mᵢ, where i=1, 2, . . . , K, each connected to a respective optical combiner OCᵢ, wherein each Mach-Zehnder modulator Mᵢ is configured to spectrally encode the combined data stream according to the 2D spectral/spatial double weight zero cross correlation code and split the respective encoded combined data stream into two equal spectrally encoded data streams.

3. The optical body area network of claim 2, wherein the continuous wave lasers Lᵢ, i=1, . . . , 8, have wavelength values λᵢ centered at λ₁=1552.5 nm, λ₂=1551.7 nm, λ3=1550.9 nm, λ₄=1550.1 nm, λ₅=1549.3 nm, λ₆=1548.5 nm, λ₇=1547.7 nm and λ₈=1546.9 nm.

4. The optical body area network of claim 2, wherein the optical coordinator further comprises:
a plurality of pseudo-random bit sequence generators; and
a plurality of non-return to zero pulse generators each connected to an output terminal of one of the pseudo-random bit sequence generators,
wherein each of the Mach-Zehnder modulators is configured with an input terminal connected to an output terminal of one of the plurality of non-return to zero pulse generators.

5. The optical body area network of claim 2, wherein the optical coordinator further comprises:
a spatial encoder which includes a first star coupler C₁, a second star coupler C₂, a third star coupler C₃, and a fourth star coupler C₄,
wherein the first star coupler C₁ is configured to combine a first one of the two equal data streams from each Mach-Zehnder modulator Mᵢ for i=1, . . . , K/2 and generate a first spectrally encoded data stream,
wherein the second star coupler C₂ is configured to combine a second one of the two equal data streams from each Mach-Zehnder modulator Mᵢ for i=1, . . . , K/2 and generate a second spectrally encoded data stream,
wherein the third star coupler C₃ is configured to combine a first one of the two equal data streams from each Mach-Zehnder modulator Mᵢ for i=K/2+1, . . . , K and generate a third spectrally encoded data stream, and
wherein the fourth star coupler C₄ is configured to combine a second one of the two equal data streams from each Mach-Zehnder modulator Mᵢ for i=K/2+1, . . . , K and generate a fourth spectrally encoded data stream.

6. The optical body area network of claim 5, wherein the optical coordinator further comprises:
a first spatially encoding time delay unit t₁ configured to receive the first spectrally data stream from the first star coupler C₁, apply a first encoded time delay and generate a first time delayed spectrally and spatially encoded data stream;
a second spatially encoding time delay unit t₂ configured to receive the second spectrally encoded data stream from the second star coupler C₂, apply a second encoded time delay and generate a second time delayed spectrally and spatially encoded data stream;
a third spatially encoding time delay unit t₃ configured to receive the third spectrally encoded data stream from the third star coupler C₃, apply a third encoded time delay and generate a third time delayed spectrally and spatially encoded data stream; and
a fourth spatially encoding time delay unit t₄ configured to receive the fourth spectrally encoded data stream from the fourth star coupler C₄, apply a fourth time delay and generate a fourth encoded time delayed spectrally and spatially encoded data stream,
wherein the first encoded time delay, the second encoded time delay, the third encoded time delay and the fourth encoded time delay are based on the spectral and spatial placement of each spectrally and spatially encoded data stream in the two dimensional (2D) spectral/spatial double weight zero cross correlation code.

7. The optical body area network of claim 6, wherein the optical coordinator further comprises an optical coupler connected to each of the spatially encoding time delay units, wherein the optical coupler is configured to combine the time delayed spectrally and spatially encoded data streams into the single optical data stream.

8. The optical body area network of claim 7, wherein the optical coordinator further comprises an optical amplifier connected to the optical coupler, wherein the optical amplifier is configured to generate the amplified single optical data stream.

9. The optical body area network of claim 8, wherein the transmitter telescope is connected to the optical amplifier.

10. The optical body area network of claim 1, wherein the optical decoder further comprises:
an optical decoupler connected to the receiver telescope, wherein the optical decoupler is configured to split the received amplified single optical data stream into four equal received data streams.

11. The optical body area network of claim 10, wherein the optical decoder further comprises:
a spatial decoder including:
a first spatially decoding time delay unit t₁′ configured to receive a first one of the four equal data streams, apply a first decoded time delay and generate a first time delayed spatially decoded data stream;
a second spatially decoding time delay unit t₂′ configured to receive a second one of the four equal data streams, apply a second decoded time delay and generate a second time delayed spatially decoded data stream;
a third spatially decoding time delay unit t₃′ configured to receive a third one of the four equal data streams, apply a third decoded time delay and generate a third time delayed spatially decoded data stream; and
a fourth spatially decoding time delay unit t₄′ configured to receive a fourth one of the four equal data streams, apply a fourth decoded time delay and generate a fourth time delayed spatially decoded data stream,
wherein the first decoded time delay, the second decoded time delay, the third decoded time delay and the fourth decoded time delay are based on the spectral and spatial placement of each spatially decoded data stream in the two dimensional (2D) spectral/spatial double weight zero cross correlation decode sequence.

12. The optical body area network of claim 11, wherein the spatial decoder further comprises:
a first star decoupler S₁′ configured to receive the first time delayed spatially decoded data stream and split the first time delayed spatially decoded data stream into a first set of four equal spatially decoded data streams;
a second star decoupler S₂′ configured to receive the second time delayed spatially decoded data stream and split the second time delayed spatially decoded data stream into a second set of four equal spatially decoded data streams;
a third star decoupler S₃′ configured to receive the third time delayed spatially decoded data stream and split the third time delayed spatially decoded data stream into a third set of four equal spatially decoded data streams; and
a fourth star decoupler S₄′ configured to receive the fourth time delayed spatially decoded data stream and split the fourth time delayed spatially decoded data stream into a fourth set of four equal spatially decoded data streams.

13. The optical body area network of claim 12, wherein the optical decoder further comprises:
a spectral decoder configured with:
a plurality of receiver circuits Rᵢ, i=1, 2, . . . , K, each including a first optical bandpass filter, a second optical bandpass filter, an optical coupler/splitter, a first photodetector, a second photodetector, a subtractor, an electrical low pass filter and a bit error rate analyzer.

14. The optical body area network of claim 13, wherein the plurality of receiver circuits Rᵢ of the spectral decoder further comprise:
a first receiver circuit R₁ in which the first optical bandpass filter is configured to receive a first one of the first set of four equal spatially decoded data streams from the first star decoupler S₁′ and a second optical bandpass filter is configured to receive a first one of the second set of four equal spatially decoded data streams from the second star decoupler S₂′, wherein the first optical bandpass filter and the second optical bandpass filter are each tuned to filter the received spatially decoded data streams to the frequency λ₁=1552.5 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal and generate a low pass filtered difference signal, wherein the bit error rate estimator is configured to estimate the bit error rate (BER) of the low pass filtered difference signal and verify signal reception when the BER is greater than or equal to 1×10⁻⁹;
a second receiver circuit R₂ in which the first optical bandpass filter is configured to receive a second one of the first set of four equal spatially decoded data streams from the first star decoupler S₁′ and a second optical bandpass filter is configured to receive a second one of the second set of four equal spatially decoded data streams from the second star decoupler S₂′, wherein the first optical bandpass filter and the second optical bandpass filter are each tuned to filter the received spatially decoded data streams to the frequency λ₂=1551.7 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹;
a third receiver circuit R₃ in which the first optical bandpass filter is configured to receive a third one of the first set of four equal spatially decoded data streams from the first star decoupler S₁′ and a second optical bandpass filter is configured to receive a third one of the second set of four equal spatially decoded data streams from the second star decoupler S₂′, wherein the first optical bandpass filter and the second optical bandpass filter are each tuned to filter the received spatially decoded data streams to the frequency λ₃=1550.9 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹;
a fourth receiver circuit R₄ in which the first optical bandpass filter is configured to receive a fourth one of first set of four equal spatially decoded data streams from the first star decoupler S₁′ and a second optical bandpass filter is configured to receive a fourth one of second set of four equal spatially decoded data streams from the second star decoupler S₂′, wherein the first optical bandpass filter and the second optical bandpass filter are each tuned to filter the received spatially decoded data streams to the frequency λ₄=1550.1 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹;
a fifth receiver circuit R₅ in which the first optical bandpass filter is configured to receive a first one of the third set of four equal spatially decoded data streams from the third star decoupler S₃′ and a second optical bandpass filter is configured to receive a first one of fourth set of four equal spatially decoded data streams from the fourth star decoupler S₄′, wherein the first optical bandpass filter and the second optical bandpass filter are each tuned to filter the received spatially decoded data streams to the frequency λ₅=1549.3 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹;
a sixth receiver circuit R₆ in which the first optical bandpass filter is configured to receive a second one of the third set of four equal spatially decoded data streams from the third star decoupler S₃′ and a second optical bandpass filter is configured to receive a second one of fourth set of four equal spatially decoded data streams from the fourth star decoupler S₄′, wherein the first optical bandpass filter and the second optical bandpass filter are each tuned to filter the received spatially decoded data streams to the frequency λ₆=1548.5 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹;
a seventh receiver circuit R₇ in which the first optical bandpass filter is configured to receive a third one of the third set of four equal spatially decoded data streams from the third star decoupler S₃′ and a second optical bandpass filter is configured to receive a third one of the fourth set of four equal spatially decoded data streams from the fourth star decoupler S₄′, wherein the first optical bandpass filter and the second optical bandpass filter are each tuned to filter the received spatially decoded data streams to the frequency λ₇=1547.7 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹; and
an eighth receiver circuit R₈ in which the first optical bandpass filter is configured to receive a fourth one of the third set of four equal spatially decoded data streams from the third star decoupler S₃′ and a second optical bandpass filter is configured to receive a fourth one of fourth set of four equal spatially decoded data streams from the fourth star decoupler S₄′, wherein the first optical bandpass filter and the second optical bandpass filter are each tuned to filter the received spatially decoded data streams to the frequency λ₈=1546.9 nm, wherein the optical coupler/splitter is configured to combine the filtered spatially decoded data streams and split the filtered spatially decoded data streams into two equal filtered spatially decoded data streams, wherein the first photodetector is configured to generate a first electrical signal upon detecting a first of the two equal filtered spatially decoded data streams and the second photodetector is configured to generate a second electrical signal upon detecting a second of the two equal filtered spatially decoded data streams, wherein the subtractor is configured to subtract the second electrical signal from the first electrical signal and generate a difference signal, wherein the electrical low pass filter is configured to receive the difference signal, wherein the bit error rate estimator is configured to estimate the bit error rate (BER) of the difference signal and verify signal reception when the BER is greater than or equal to 1×10⁻⁹.

15. A method for transmission of optical body area network signals over a free space optical network, comprising:
generating, by each of a plurality of on-body optical sensors Kᵢ, where i=1, 2, . . . , 8, optical signals based on a measurement by a respective on-body optical sensor;
receiving, by an optical coordinator, the optical signals from each on-body optical sensor Kᵢ;
spectrally and spatially encoding, by the optical coordinator, the optical signals according to a two dimensional (2D) spectral/spatial double weight zero cross correlation code
applying, by the optical coordinator, an encoded time delay to the spectrally and spatially encoded optical signals;
combining, by an optical coupler, the encoded time delayed spectrally and spatially encoded optical signals into a single optical data stream;
amplifying, by an amplifier, the single optical data stream;
receiving, by a transmitter telescope, the amplified single optical data stream;
transmitting the amplified single optical data stream over a free space optical channel;
receiving, by a receiver telescope, the amplified single optical data stream;
splitting, by an optical decoder, the received amplified single optical data streams into four equal received data streams;
applying, by the optical decoder, a decoding time delay to each of the four equal received optical data streams;
spatially and spectrally decoding, by the optical decoder, the four decoded time delayed equal received optical data streams according to a 2D spatial/spectral double weight zero cross correlation decode sequence;
generating, by the optical decoder, eight decoded optical signals;
low pass filtering, by a low pass filter, the eight decoded optical signals; and
performing, by a bit error rate BER estimator, a BER measurement on each of the eight decoded optical signals; and
verifying, by the bit error rate BER estimator, signal reception when the BER is greater than or equal to 1×10⁻⁹.

16. The method of claim 15, wherein spectrally encoding, by the optical coordinator, the optical signals, comprises:
generating, from each of a plurality of continuous wave lasers Sᵢ, where i=1, 2, . . . , K, an optical data stream based on a respective one of the received optical signals;
splitting, by a plurality of power splitters Sᵢ, where i=1, 2, . . . , K, each optical data stream into two equal length optical data streams;
combining, by a plurality of optical combiners OCᵢ, where i=1, 2, . . . , K, each one of the two equal length optical data streams with one of the two equal length optical data streams from a different power splitter;
generating, by each optical combiner OCᵢ, a combined data stream, wherein each combined data stream is a unique combination of equal length optical data streams; and
spectrally encoding, by a plurality of Mach-Zehnder modulators Mᵢ, where i=1, 2, . . . , K, each connected to a respective optical combiner OCᵢ, each combined data stream according to the 2D spectral/spatial double weight zero cross correlation code; and
splitting each encoded combined data stream into two equal spectrally encoded data streams.

17. The method of claim 16, wherein spatially encoding each of the two equal spectrally encoded data streams comprises:
combining, by a first star coupler C₁, a first one of the two equal data streams from each Mach-Zehnder modulator Mᵢ for i=1, . . . , K/2;
generating, by the first star coupler C₁, a first spectrally encoded data stream,
combining, by a second star coupler C₂, a second one of the two equal data streams from each Mach-Zehnder modulator Mᵢ;
generating, by the second star coupler C₂, a second spectrally encoded data stream;
combining, by a third star coupler C₃, a third one of the two equal data streams from each Mach-Zehnder modulator Mᵢ;
generating, by the third star coupler C₃, a third spectrally encoded data stream;
combining, by a fourth star coupler C₄, a fourth one of the two equal data streams from each Mach-Zehnder modulator Mᵢ; and
generating a fourth spectrally encoded data stream.

18. The method of claim 17, wherein applying a time delay to each spectrally encoded data stream comprises:
receiving, by a first spatially encoding time delay unit t₁, the first spectrally data stream from the first star coupler C₁, applying a first encoded time delay and generating a first time delayed spectrally and spatially encoded data stream;
receiving, by a second spatially encoding time delay unit t₂, the second spectrally encoded data stream from the second star coupler C₂, applying a second encoded time delay and generating a second time delayed spectrally and spatially encoded data stream;
receiving, by a third spatially encoding time delay unit t₃, the third spectrally encoded data stream from the third star coupler C₃, applying a third encoded time delay and generating a third time delayed spectrally and spatially encoded data stream; and
receiving, by a fourth spatially encoding time delay unit t₄, the fourth spectrally encoded data stream from the fourth star coupler C₄, applying a fourth time delay and generating a fourth encoded time delayed spectrally and spatially encoded data stream,
wherein the first time delay, the second time delay, the third time delay and the fourth time delay are based on the spectral and spatial placement of each spectrally and spatially encoded data stream in the two dimensional (2D) spectral/spatial double weight zero cross correlation code;
combining, by an optical coupler connected to each of the spatially encoding time delay units, the time delayed spectrally and spatially encoded data streams into the single optical data stream; and
generating, by an optical amplifier connected to the optical coupler, the amplified single optical data stream.

19. The method of claim 15, further comprising:
splitting, by an optical decoupler connected to the receiver telescope, the received amplified single optical data stream into four equal received data streams;
spatially decoding the four equal received data streams by:
receiving, by a first spatially decoding time delay unit t₁′, a first one of the four equal data streams, applying a first decoded time delay and generating a first time delayed spatially decoded data stream;
receiving, by a second spatially decoding time delay unit t₂′, a second one of the four equal data streams, applying a second decoded time delay and generating a second time delayed spatially decoded data stream;
receiving, by a third spatially decoding time delay unit t₂′, a third one of the four equal data streams, applying a third decoded time delay and generating a third time delayed spatially decoded data stream; and
receiving, by a fourth spatially decoding time delay unit t₂′, a fourth one of the four equal data streams, applying a fourth decoded time delay and generating a fourth time delayed spatially decoded data stream,
wherein the first decoded time delay, the second decoded time delay, the third decoded time delay and the fourth decoded time delay are based on the spectral and spatial placement of each spatially decoded data stream in the two dimensional (2D) spectral/spatial double weight zero cross correlation decode sequence;
receiving, by a first star decoupler S₁′, the first time delayed spatially decoded data stream, and splitting the first time delayed spatially decoded data stream into a first set of four equal spatially decoded data streams;
receiving, by a second star decoupler S₂′, the second time delayed spatially decoded data stream and splitting the second time delayed spatially decoded data stream into a second set of four equal spatially decoded data streams;
receiving, by a third star decoupler S₃′, the third time delayed spatially decoded data stream and splitting the third time delayed spatially decoded data stream into a third set of four equal spatially decoded data streams; and
splitting, by a fourth star decoupler S₄′, the fourth time delayed spatially decoded data stream and splitting the fourth time delayed spatially decoded data stream into a fourth set of four equal spatially decoded data streams.

20. The method of claim 19, further comprising:
spectrally decoding the first set of four equal spatially decoded data streams, the second set of four equal spatially decoded data streams, the third set of four equal spatially decoded data streams and the fourth set of four equal spatially decoded data streams, by:
receiving, by a first optical bandpass filter of a first receiver circuit R₁, a first one of the first set of four equal spatially decoded data streams from the first star decoupler S₁′;
receiving, by a second optical bandpass filter of the first receiver circuit R₁, a first one of the second set of four equal spatially decoded data streams from the second star decoupler S₂′;
filtering, by the first optical bandpass filter and the second optical bandpass filter of the first receiver circuit R₁, the received spatially decoded data streams to a frequency λ₁=1552.5 nm;
combining, by an optical coupler/splitter filter of the first receiver circuit R₁, the filtered spatially decoded data streams;
splitting, by the optical coupler/splitter filter of the first receiver circuit R₁, the filtered spatially decoded data streams into two equal filtered spatially decoded data streams;
generating, by a first photodetector filter of the first receiver circuit R₁, a first electrical signal upon detecting a first of the two equal filtered spatially decoded data streams;
generating, by a second photodetector filter of the first receiver circuit R₁, a second electrical signal upon detecting a second of the two equal filtered spatially decoded data streams;
subtracting, by a subtractor of the first receiver circuit R₁, the second electrical signal from the first electrical signal and generating a difference signal;
low pass filtering, by an electrical low pass filter of the first receiver circuit R₁, the difference signal and generating a low pass filtered difference signal;
estimating, by a bit error rate estimator filter of the first receiver circuit R₁, a bit error rate (BER) of the low pass filtered difference signal and verifying signal reception when the BER is greater than or equal to 1×10⁻⁹;
receiving, by a first optical bandpass filter of a second receiver circuit R₂, a second one of the first set of four equal spatially decoded data streams from the first star decoupler S₁′;
receiving, by a second optical bandpass filter of the second receiver circuit R₂, a second one of the second set of four equal spatially decoded data streams from the second star decoupler S₂′;
filtering, by the first optical bandpass filter and the second optical bandpass filter of the second receiver circuit R₂, the received spatially decoded data streams to a frequency λ₂=1551.7 nm;
combining, by an optical coupler/splitter filter of the second receiver circuit R₂, the filtered spatially decoded data streams;
splitting, by the optical coupler/splitter filter of the second receiver circuit R₂, the filtered spatially decoded data streams into two equal filtered spatially decoded data streams;
generating, by a first photodetector of the second receiver circuit R₂, a first electrical signal upon detecting a first of the two equal filtered spatially decoded data streams;
generating, by a second photodetector of the second receiver circuit R₂, a second electrical signal upon detecting a second of the two equal filtered spatially decoded data streams;
subtracting, by a subtractor of the second receiver circuit R₂, the second electrical signal from the first electrical signal and generating a difference signal;
low pass filtering, by an electrical low pass filter of the second receiver circuit R₂, the difference signal and generating a low pass filtered difference signal;
estimating, by a bit error rate estimator of the second receiver circuit R₂, a bit error rate of the low pass filtered difference signal and verifying signal reception when the BER is greater than or equal to 1×10⁻⁹;
receiving, by a first optical bandpass filter of a third receiver circuit R₃, a third one of the first set of four equal spatially decoded data streams from the first star decoupler S₁′;
receiving, by a second optical bandpass filter of the third receiver circuit R₃, a third one of the second set of four equal spatially decoded data streams from the second star decoupler S₂′;
filtering, by the first optical bandpass filter and the second optical bandpass filter of the third receiver circuit R₃, the received spatially decoded data streams to the frequency λ₃=1550.9 nm;
combining, by an optical coupler/splitter of the third receiver circuit R₃, the filtered spatially decoded data streams;
splitting, by the optical coupler/splitter of the third receiver circuit R₃, the filtered spatially decoded data streams into two equal filtered spatially decoded data streams;
generating, by a first photodetector of the third receiver circuit R₃, a first electrical signal upon detecting a first of the two equal filtered spatially decoded data streams;
generating, by a second photodetector of the third receiver circuit R₃, a second electrical signal upon detecting a second of the two equal filtered spatially decoded data streams;
subtracting, by a subtractor of the third receiver circuit R₃, the second electrical signal from the first electrical signal and generating a difference signal;
low pass filtering, by an electrical low pass filter of the third receiver circuit R₃, the difference signal and generating a low pass filtered difference signal;
estimating, by a bit error rate estimator of the third receiver circuit R₃, a bit error rate of the low pass filtered difference signal and verifying signal reception when the BER is greater than or equal to 1×10⁻⁹;
receiving, by a first optical bandpass filter of a fourth receiver circuit R₄, a fourth one of the first set of four equal spatially decoded data streams from a first star decoupler S₁′;
receiving, by a second optical bandpass filter of the fourth receiver circuit R₄, a fourth one of second set of four equal spatially decoded data streams from the second star decoupler S₂′;
filtering, by the first optical bandpass filter and the second optical bandpass filter of the fourth receiver circuit R₄, the received spatially decoded data streams to a frequency λ₄=1550.1 nm;
combining, by an optical coupler/splitter of the fourth receiver circuit R₄, the filtered spatially decoded data streams;
splitting, by the optical coupler/splitter of the fourth receiver circuit R₄, the filtered spatially decoded data streams into two equal filtered spatially decoded data streams;
generating, by a first photodetector of the fourth receiver circuit R₄, a first electrical signal upon detecting a first of the two equal filtered spatially decoded data generating, by a second photodetector of the fourth receiver circuit R₄, a second electrical signal upon detecting a second of the two equal filtered spatially decoded data streams;
subtracting, by a subtractor of the fourth receiver circuit R₄, the second electrical signal from the first electrical signal and generating a difference signal;
low pass filtering, by an electrical low pass filter of the fourth receiver circuit R₄, the difference signal and generating a low pass filtered difference signal;
estimating, by a bit error rate estimator of the fourth receiver circuit R₄, a bit error rate of the low pass filtered difference signal and verifying signal reception when the BER is greater than or equal to 1×10⁻⁹;
receiving, by a first optical bandpass filter of a fifth receiver circuit R₅, a first one of the third set of four equal spatially decoded data streams from the third star decoupler S₃′;
receiving, by a second optical bandpass filter of the fifth receiver circuit R₅, a first one of fourth set of four equal spatially decoded data streams from the fourth star decoupler S₄′;
filtering, by the first optical bandpass filter and the second optical bandpass filter of the fifth receiver circuit R₅, the received spatially decoded data streams to the frequency λ₅=1549.3 nm;
combining, by an optical coupler/splitter of the fifth receiver circuit R₅, the filtered spatially decoded data streams;
splitting, by the optical coupler/splitter of the fifth receiver circuit R₅, the filtered spatially decoded data streams into two equal filtered spatially decoded data
generating, by a first photodetector of the fifth receiver circuit R₅, a first electrical signal upon detecting a first of the two equal filtered spatially decoded data streams;
generating, by a second photodetector of the fifth receiver circuit R₅, a second electrical signal upon detecting a second of the two equal filtered spatially decoded data streams;
subtracting, by a subtractor of the fifth receiver circuit R₅, the second electrical signal from the first electrical signal and generating a difference signal;
low pass filtering, by an electrical low pass filter of the fifth receiver circuit R₅, the difference signal and generating a low pass filtered difference signal;
estimating, by a bit error rate estimator of the fifth receiver circuit R₅, a bit error rate of the low pass filtered difference signal and verifying signal reception when the BER is greater than or equal to 1×10⁻⁹;
receiving, by a first optical bandpass filter of a sixth receiver circuit R₆, a second one of the third set of four equal spatially decoded data streams from the third star decoupler S₃′;
receiving, by a second optical bandpass filter of the sixth receiver circuit R₆, a second one of fourth set of four equal spatially decoded data streams from the fourth star decoupler S₄′;
filtering, by the first optical bandpass filter and the second optical bandpass filter sixth receiver circuit R₆, the received spatially decoded data streams to the frequency λ₆=1548.5 nm;
combining, by an optical coupler/splitter of the sixth receiver circuit R₆, the filtered spatially decoded data streams;
splitting, by the optical coupler/splitter of the sixth receiver circuit R₆, the filtered spatially decoded data streams into two equal filtered spatially decoded data streams;
generating, by a first photodetector of the sixth receiver circuit R₆, a first electrical signal upon detecting a first of the two equal filtered spatially decoded data streams;
generating, by a second photodetector of the sixth receiver circuit R₆, second electrical signal upon detecting a second of the two equal filtered spatially decoded data streams;
subtracting, by a subtractor of the sixth receiver circuit R₆, the second electrical signal from the first electrical signal and generating a difference signal;
low pass filtering, by an electrical low pass filter of the sixth receiver circuit R₆, the difference signal and generating a low pass filtered difference signal;
estimating, by a bit error rate estimator of the sixth receiver circuit R₆, the bit error rate of the low pass filtered difference signal and verifying signal reception when the BER is greater than or equal to 1×10⁻⁹;
receiving, by a first optical bandpass filter of a seventh receiver circuit R₇, a third one of the third set of four equal spatially decoded data streams from the third star decoupler S₃′;
receiving, by a second optical bandpass filter of the seventh receiver circuit R₇, third one of the fourth set of four equal spatially decoded data streams from the fourth star decoupler S₄′;
filtering, by the first optical bandpass filter and the second optical bandpass filter of the seventh receiver circuit R₇, the received spatially decoded data streams to a frequency λ₇=1547.7 nm;
combining, by an optical coupler/splitter filter of the seventh receiver circuit R₇, the filtered spatially decoded data streams;
splitting, by the optical coupler/splitter filter of the seventh receiver circuit R₇, the filtered spatially decoded data streams into two equal filtered spatially decoded data streams;
generating, by a first photodetector of the seventh receiver circuit R₇, a first electrical signal upon detecting a first of the two equal filtered spatially decoded data streams;
generating, by a second photodetector of the seventh receiver circuit R₇, a second electrical signal upon detecting a second of the two equal filtered spatially decoded data streams;
subtracting, by a subtractor of the seventh receiver circuit R₇, the second electrical signal from the first electrical signal and generating a difference signal;
low pass filtering, by an electrical low pass filter of the seventh receiver circuit R₇, the difference signal and generating a low pass filtered difference signal;
estimating, by a bit error rate estimator of the seventh receiver circuit R₇, a bit error rate of the difference signal and verifying signal reception when the BER is greater than or equal to 1×10⁻⁹; and
receiving, by a first optical bandpass filter of an eighth receiver circuit R₈, a fourth one of the third set of four equal spatially decoded data streams from the third star decoupler S₃′;
receiving, by a second optical bandpass filter of the eighth receiver circuit R₈, a fourth one of the fourth set of four equal spatially decoded data streams from the fourth star decoupler S₄′;
filtering, by the first optical bandpass filter and the second optical bandpass filter of the eighth receiver circuit R₈, the received spatially decoded data streams to the frequency λ₈=1546.9 nm;
combining, by an optical coupler/splitter of the eighth receiver circuit R₈, the filtered spatially decoded data streams;
splitting, by the optical coupler/splitter of the eighth receiver circuit R₈, the filtered spatially decoded data streams into two equal filtered spatially decoded data streams;
generating, by a first photodetector of the eighth receiver circuit R₈, a first electrical signal upon detecting a first of the two equal filtered spatially decoded data streams;
generating, by the second photodetector of the eighth receiver circuit R₈, a second electrical signal upon detecting a second of the two equal filtered spatially decoded data streams;
subtracting, by a subtractor of the eighth receiver circuit R₈, the second electrical signal from the first electrical signal and generating a difference signal;
low pass filtering, by an electrical low pass filter of the eighth receiver circuit R₈, the difference signal and generating a low pass filtered difference signal; and
estimating, by a bit error rate estimator filter of the eighth receiver circuit R₈, a bit error rate of the low pass filtered difference signal and verifying signal reception when the BER is greater than or equal to 1×10⁻⁹.
